(19) United States
(12) Patent Application Publication
(10) Pub. No.: US 2023/0422256 A1
(43) Pub. Date: Dec. 28, 2023

(54) PHYSICAL LAYER ASSOCIATION OF EXTENDED REALITY DATA

(71) Applicant: QUALCOMM Incorporated, San Diego, CA (US)

(72) Inventors: Huilin Xu, Temecula, CA (US); Jay Kumar Sundararajan, San Diego, CA (US); Yuchul Kim, San Diego, CA (US); Linhai He, San Diego, CA (US); Peter Gaal, San Diego, CA (US); Wanshi Chen, San Diego, CA (US); Seyedkianoush Hosseini, San Diego, CA (US); Nicolas Cornillet, Lannion (FR)

(21) Appl. No.: 17/849,869

(22) Filed: Jun. 27, 2022

(51) Int. Cl. H04W 72/14; H04L 5/00; H04W 28/08; H04L 47/56; H04L 47/283

(52) U.S. Cl. CPC H04W 72/14; H04L 5/0048; H04W 28/0975; H04L 47/56; H04L 47/283

(57) ABSTRACT

Methods, systems, and devices for wireless communications are described. The method may include a user equipment (UE) receiving first control information that includes a first packet data unit (PDU) set identifier (ID) associated with a set of different PDUs that collectively represent a data unit for decoding. Upon receiving the first control information, the UE may identify a PDU is a part of the set of different PDUs that corresponds to the first PDU set ID based on the first control information and determine whether to include the PDU in communications with a network entity based on the PDU being part of the set of different PDUs.

### FIELD OF TECHNOLOGY

The following relates to wireless communications, including physical layer association of extended reality data.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some examples, a wireless communications system may support extended reality (XR). To support XR, a network entity (e.g., a base station) may transmit a set of packet data units (PDUs) to a UE (e.g., an XR device) and the UE may collectively decode the set of PDUs to obtain a video frame.

### SUMMARY

The described techniques relate to improved methods, systems, devices, and apparatuses that support physical layer association of extended reality data. For example, the described techniques provide for a user equipment (UE) to identify a correlation between packet data units (PDUs) on a physical layer. In some examples, the UE may receive first control information that includes a first PDU set identifier (ID) associated with a set of different PDUs that collectively represent a data unit for decoding. The first control information may be included in downlink control information (DCI) (e.g., scheduling DCI or activation DCI). Upon receiving the first control information, the UE may identify that a PDU is included in the set of PDUs and determine whether to transmit or monitor for the PDU based on the PDU being included in the set of PDUs. In one example, the UE may elect to not transmit or monitor for the PDU if the PDU is scheduled to be received after a time duration (e.g., packet delay budget (PDB)) or if the UE receives second control information scheduling the UE to receive or monitor for PDUs associated with a second PDU set ID during a same time the UE is to monitor for or receive the PDU. The methods described herein may enable a UE to refrain from monitoring or transmitting one or more PDUs of a PDU set in some scenarios (e.g., when exceeding the PDB) which may decrease processing power at the UE and result in a more efficient use of resources.

A method for wireless communication at a UE is described. The method may include receiving first control information that includes a first PDU set ID associated with a set of different PDUs that collectively represent a data unit for decoding, identifying a PDU is a part of the set of different PDUs that corresponds to the first PDU set ID based on the first control information, and determining whether to include the PDU in communications with a network entity, where the determining is based on the PDU being part of the set of different PDUs associated with the first PDU set ID.

An apparatus for wireless communication at a UE is described. The apparatus may include a processor, memory coupled with the processor, and instructions stored in the memory. The instructions may be executable by the processor to cause the apparatus to receive first control information that includes a first PDU set ID associated with a set of different PDUs that collectively represent a data unit for decoding, identify a PDU is a part of the set of different PDUs that corresponds to the first PDU set ID based on the first control information, and determine whether to include the PDU in communications with a network entity, where the determining is based on the PDU being part of the set of different PDUs associated with the first PDU set ID.

Another apparatus for wireless communication at a UE is described. The apparatus may include means for receiving first control information that includes a first PDU set ID associated with a set of different PDUs that collectively represent a data unit for decoding, means for identifying a PDU is a part of the set of different PDUs that corresponds to the first PDU set ID based on the first control information, and means for determining whether to include the PDU in communications with a network entity, where the determining is based on the PDU being part of the set of different PDUs associated with the first PDU set ID.

A non-transitory computer-readable medium storing code for wireless communication at a UE is described. The code may include instructions executable by a processor to receive first control information that includes a first PDU set ID associated with a set of different PDUs that collectively represent a data unit for decoding, identify a PDU is a part of the set of different PDUs that corresponds to the first PDU set ID based on the first control information, and determine whether to include the PDU in communications with a network entity, where the determining is based on the PDU being part of the set of different PDUs associated with the first PDU set ID.

Some examples of the method, apparatuses, and non-transitory computer-readable medium described herein may further include operations, features, means, or instructions for transmitting, to the network entity, a first subset of the set of different PDUs during a first time duration, identifying that the PDU may be part of a second subset of the set of different PDUs that may be scheduled to be transmitted after the first time duration, and refraining from transmitting, to the network entity, the second subset of the set of different PDUs based on the second subset being scheduled to be transmitted after the first time duration, where the PDU may be not included in the communications with the network entity as a result of the PDU being in the second subset of the set of different PDUs.

In some examples of the method, apparatuses, and non-transitory computer-readable medium described herein, the first time duration may be based on a PDB associated with the first PDU set ID.

Some examples of the method, apparatuses, and non-transitory computer-readable medium described herein may further include operations, features, means, or instructions for transmitting, to the network entity, a first subset of the set of different PDUs, receiving, after transmission of the first subset of the set of different PDUs and before transmission of a second subset of the set of different PDUs, second control information that includes a second PDU set ID that may be different from the first PDU set ID, and refraining from transmitting, to the network entity, the second subset of the set of different PDUs based on the second control information being received before transmission of the second subset of the set of different PDUs, where the PDU may be not included in the communications with the network entity as a result of the PDU being in the second subset of the set of different PDUs.

Some examples of the method, apparatuses, and non-transitory computer-readable medium described herein may further include operations, features, means, or instructions for transmitting, to the network entity, a first subset of the set of different PDUs, receiving, after transmission of the first subset of the set of different PDUs and before transmission of a second subset of the set of different PDUs, a cancelation signal that indicates that transmission of one or more PDUs of the set of different PDUs may be canceled, and refraining from transmitting, to the network entity, the second subset of the set of different PDUs based on the cancelation signal being received before transmission of the second subset of the set of different PDUs, where the PDU may be not included in the communications with the network entity as a result of the PDU being in the second subset of the set of different PDUs.

Some examples of the method, apparatuses, and non-transitory computer-readable medium described herein may further include operations, features, means, or instructions for receiving, from the network entity, a first subset of the set of different PDUs during a first time duration, identifying that the PDU may be part of a second subset of the set of different PDUs that may be scheduled to be received after the first time duration, and refraining from monitoring for the second subset of the set of different PDUs based on the second subset being scheduled to be received after the first time duration, where the PDU may be not included in the communications with the network entity as a result of the PDU being in the second subset of the set of different PDUs.

In some examples of the method, apparatuses, and non-transitory computer-readable medium described herein, the first time duration may be based on a PDB associated with the first PDU set ID.

Some examples of the method, apparatuses, and non-transitory computer-readable medium described herein may further include operations, features, means, or instructions for receiving, from the network entity, a first subset of the set of different PDUs, receiving, after receipt of the first subset of the set of different PDUs and before receipt of a second subset of the set of different PDUs, second control information that includes a second PDU set ID that may be different from the first PDU set ID, and refraining from monitoring for the second subset of the set of different PDUs based on the second control information being received before receipt of the second subset of the set of different PDUs, where the PDU may be not included in the communications with the network entity as a result of the PDU being in the second subset of the set of different PDUs.

Some examples of the method, apparatuses, and non-transitory computer-readable medium described herein may further include operations, features, means, or instructions for receiving, from the network entity, a first subset of the set of different PDUs, receiving, after receipt of the first subset of the set of different PDUs and before receipt of a second subset of the set of different PDUs, a cancelation signal that indicates that transmission by the network entity of one or more PDUs of the set of different PDUs may be canceled, and refraining from monitoring for the second subset of the set of different PDUs based on the cancelation signal being received before receipt of the second subset of the set of different PDUs, where the PDU may be not included in the communications with the network entity as a result of the PDU being in the second subset of the set of different PDUs.

In some examples of the method, apparatuses, and non-transitory computer-readable medium described herein, receiving the first control information that includes the first PDU set ID may include operations, features, means, or instructions for receiving the first control information in association with a semi-persistent scheduling (SPS) configuration or a configured grant (CG) configuration, where reception or transmission opportunities associated with the SPS configuration or the CG configuration, respectively, may be scheduled in accordance with a minimum size of a PDU set, a first subset of the set of different PDUs being received or transmitted during the reception or transmission opportunities.

Some examples of the method, apparatuses, and non-transitory computer-readable medium described herein may further include operations, features, means, or instructions for receiving, via a dynamic grant (DG), second control information that includes the first PDU set ID, the second control information scheduling a second subset of the set of different PDUs for receipt or transmission, the second subset including one or more PDUs that were not included in the first subset.

In some examples of the method, apparatuses, and non-transitory computer-readable medium described herein, receiving the first control information that includes the first PDU set ID may include operations, features, means, or instructions for receiving the first control information via a DG.

In some examples of the method, apparatuses, and non-transitory computer-readable medium described herein, receiving the first control information that includes the first PDU set ID may include operations, features, means, or instructions for receiving the first control information via activation DCI that activates an SPS configuration or a CG configuration.

In some examples of the method, apparatuses, and non-transitory computer-readable medium described herein, the first PDU set ID in the first control information pertains to a first activated resource instance of the SPS configuration or of the CG configuration.

In some examples of the method, apparatuses, and non-transitory computer-readable medium described herein, subsequent activated resource instances of the SPS configuration or of the CG configuration that may be subsequent to the first activated resource instance may be associated with different PDU set IDs that may have an incremented value with respect to previous activated resource instances.

Some examples of the method, apparatuses, and non-transitory computer-readable medium described herein may further include operations, features, means, or instructions for encoding the set of different PDUs based on the first PDU set ID, where an encoding scheme used for encoding the set of different PDUs includes joint encoding over multiple slots associated with the first PDU set ID, over resources scheduled via SPS and via DG associated with the first PDU set ID, over resources scheduled via CG and via DG associated with the first PDU set ID, or combinations thereof.

Some examples of the method, apparatuses, and non-transitory computer-readable medium described herein may further include operations, features, means, or instructions for decoding the set of different PDUs based on the first PDU set ID, where a decoding scheme used for decoding the set of different PDUs includes joint decoding over multiple slots associated with the first PDU set ID, over resources scheduled via SPS and via DG associated with the first PDU set ID, over resources scheduled via CG and via DG associated with the first PDU set ID, or combinations thereof.

In some examples of the method, apparatuses, and non-transitory computer-readable medium described herein, a coding scheme used to decode or encode the set of different PDUs includes a rateless code.

In some examples of the method, apparatuses, and non-transitory computer-readable medium described herein, the first PDU set ID includes one bit with a logic value of one or zero. In some examples of the method, apparatuses, and non-transitory computer-readable medium described herein, the first PDU set ID includes more than one bit.

In some examples of the method, apparatuses, and non-transitory computer-readable medium described herein, PDU set-based transmission may be enabled via a SPS configuration or a CG configuration, via a non-fallback DCI message, via a dedicated control resource set or search space designated for enabling PDU set-based transmission, or via a DCI message designated for enabling PDU set-based transmission.

A method for wireless communication at a network entity is described. The method may include transmitting first control information that includes a first PDU set ID associated with a set of different PDUs that collectively represent a data unit for decoding and determining whether to include a PDU in communications with a UE, where the determining is based on the PDU being part of the set of different PDUs associated with the first PDU set ID.

An apparatus for wireless communication at a network entity is described. The apparatus may include a processor, memory coupled with the processor, and instructions stored in the memory. The instructions may be executable by the processor to cause the apparatus to transmit first control information that includes a first PDU set ID associated with a set of different PDUs that collectively represent a data unit for decoding and determine whether to include a PDU in communications with a UE, where the determining is based on the PDU being part of the set of different PDUs associated with the first PDU set ID.

Another apparatus for wireless communication at a network entity is described. The apparatus may include means for transmitting first control information that includes a first PDU set ID associated with a set of different PDUs that collectively represent a data unit for decoding and means for determining whether to include a PDU in communications with a UE, where the determining is based on the PDU being part of the set of different PDUs associated with the first PDU set ID.

A non-transitory computer-readable medium storing code for wireless communication at a network entity is described. The code may include instructions executable by a processor to transmit first control information that includes a first PDU set ID associated with a set of different PDUs that collectively represent a data unit for decoding and determine whether to include a PDU in communications with a UE, where the determining is based on the PDU being part of the set of different PDUs associated with the first PDU set ID.

Some examples of the method, apparatuses, and non-transitory computer-readable medium described herein may further include operations, features, means, or instructions for receiving, from the UE, a first subset of the set of different PDUs during a first time duration, identifying that the PDU may be part of a second subset of the set of different PDUs that may be scheduled to be received after the first time duration, and refraining from monitoring for the second subset of the set of different PDUs based on the second subset being scheduled to be received after the first time duration, where the PDU may be not included in the communications with the network entity as a result of the PDU being in the second subset of the set of different PDUs.

Some examples of the method, apparatuses, and non-transitory computer-readable medium described herein may further include operations, features, means, or instructions for receiving, from the UE, a first subset of the set of different PDUs, transmitting, after receipt of the first subset of the set of different PDUs and before receipt of a second subset of the set of different PDUs, second control information that includes a second PDU set ID that may be different from the first PDU set ID, and refraining from monitoring for the second subset of the set of different PDUs based on the second control information being transmitted before receipt of the second subset of the set of different PDUs, where the PDU may be not included in the communications with the network entity as a result of the PDU being in the second subset of the set of different PDUs.

Some examples of the method, apparatuses, and non-transitory computer-readable medium described herein may further include operations, features, means, or instructions for transmitting, to the UE, a first subset of the set of different PDUs during a first time duration, identifying that the PDU may be part of a second subset of the set of different PDUs that may be scheduled to be transmitted after the first time duration, and refraining from transmitting, to the UE, the second subset of the set of different PDUs based on the second subset being scheduled to be transmitted after the first time duration, where the PDU may be not included in the communications with the network entity as a result of the PDU being in the second subset of the set of different PDUs.

Some examples of the method, apparatuses, and non-transitory computer-readable medium described herein may further include operations, features, means, or instructions for transmitting, to the UE, a first subset of the set of different PDUs, transmitting, after transmission of the first subset of the set of different PDUs and before transmission of a second subset of the set of different PDUs, second control information that includes a second PDU set ID that may be different from the first PDU set ID, and refraining from transmitting, to the UE, the second subset of the set of different PDUs based on the second control information being transmitted before transmission of the second subset of the set of different PDUs, where the PDU may be not included in the communications with the network entity as a result of the PDU being in the second subset of the set of different PDUs.

### BRIEF DESCRIPTION OF THE DRAWINGS

FIGS. 1 and 2 illustrate examples of a wireless communications system that supports physical layer association of extended reality data in accordance with one or more aspects of the present disclosure.

FIGS. 3A, 3B, and 3C illustrate examples of a scheduling scheme that supports physical layer association of extended reality data in accordance with one or more aspects of the present disclosure.

FIGS. 4A, 4B, and 4C illustrate examples of a cancellation scheme that supports physical layer association of extended reality data in accordance with one or more aspects of the present disclosure.

FIG. 5 illustrates an example of a process flow that supports physical layer association of extended reality data in accordance with one or more aspects of the present disclosure.

FIGS. 6 and 7 show block diagrams of devices that support physical layer association of extended reality data in accordance with one or more aspects of the present disclosure.

FIG. 8 shows a block diagram of a communications manager that supports physical layer association of extended reality data in accordance with one or more aspects of the present disclosure.

FIG. 9 shows a diagram of a system including a device that supports physical layer association of extended reality data in accordance with one or more aspects of the present disclosure.

FIGS. 10 and 11 show block diagrams of devices that support physical layer association of extended reality data in accordance with one or more aspects of the present disclosure.

FIG. 12 shows a block diagram of a communications manager that supports physical layer association of extended reality data in accordance with one or more aspects of the present disclosure.

FIG. 13 shows a diagram of a system including a device that supports physical layer association of extended reality data in accordance with one or more aspects of the present disclosure.

FIGS. 14 through 19 show flowcharts illustrating methods that support physical layer association of extended reality data in accordance with one or more aspects of the present disclosure.

### DETAILED DESCRIPTION

In some examples, a wireless communications system may support extended reality (XR). Extended reality may include augmented reality (AR), mixed reality (MR), and virtual reality (VR). To support XR, a user equipment (UE) may transmit or receive packet data units (PDUs) collectively known as a PDU set, where each PDU of the PDU set is to be decoded together, meaning that the PDUs in a PDU set collectively represent the packet data to be decoded. In some examples, all PDUs scheduled by the same dynamic grant may belong to a same PDU set and all PDUs on a same semi-persistent scheduling (SPS) occasion or a configured grant (CG) occasion may belong to a same PDU set. However, the UE or the network entity may be unaware that the PDUs belong to the same PDU set. Having such knowledge may allow a UE or a network entity to make decisions to reduce signaling overhead, reduce latency, or reduce processing.

In some examples, a wireless communications system may support physical layer association of XR data. For example, a UE may receive control information from a network entity indicating a PDU set identifier (ID) for a set of PDUs. The control information may be a dynamic grant or an activation downlink control information (DCI) for SPS or a CG. The set of PDUs corresponding to the PDU set ID may be PDUs scheduled to be transmitted or received by the dynamic grant or the PDUs to be received or transmitted over an SPS or CG occasion. Upon receiving the control information, the UE may receive (e.g., downlink) or transmit (e.g., uplink) at least a subset of the set of PDUs. In some examples, the UE may refrain from transmitting or monitoring for a second subset of the set of PDUs based on receiving a second PDU set ID different from the PDU set ID prior to transmitting or monitoring for the second subset of the set of PDUs, receiving cancellation signaling canceling a PDU of the second subset of PDUs, or exceeding a validation duration (e.g., packet delay budget (PDB)). In some examples, the PDU set ID may be indicated using one bit with a logic value of either 0 or 1. If the control information is an activation DCI for SPS or a CG, the control information may include a PDU set ID for the first SPS or CG occasion and for each subsequent SPS or CG occasion, the PDU set ID may be toggled. Moreover, the UE or the network entity may jointly encode or decode PDUs that correspond to a same PDU set ID. Providing the UE with a PDU set ID may allow the UE or the network entity to drop XR data when exceeding the PDB which may reduce overhead signaling. Additionally, providing the UE with the PDU set ID may allow the UE or the network entity to jointly decode or encode PDUs corresponding to a same PDU set ID which may result in more efficient processing.

Aspects of the disclosure are initially described in the context of wireless communications systems. Additional aspects of the disclosure are described in the context of scheduling schemes, cancellation scheme, or a process flow. Aspects of the disclosure are further illustrated by and described with reference to apparatus diagrams, system diagrams, and flowcharts that relate to physical layer association of extended reality data.

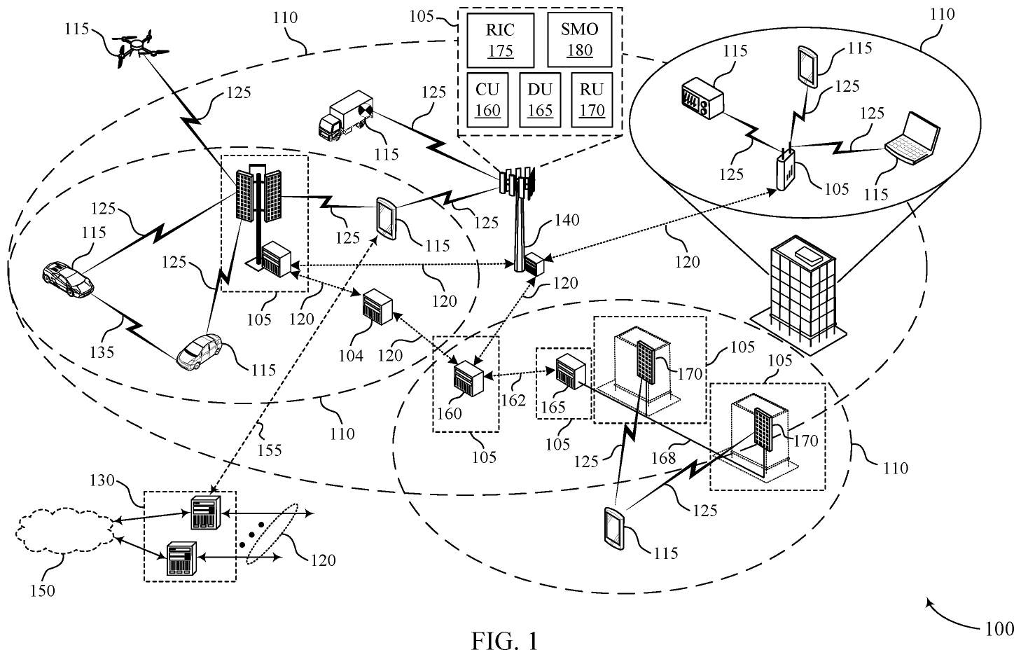

FIG. 1 illustrates an example of a wireless communications system 100 that supports physical layer association of extended reality data in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT MC), a Non-Real Time RIC (Non-RT MC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending upon which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support physical layer association of extended reality data as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

As described herein, a UE 115 may identify a correlation between packet data units (PDUs) carrying XR data on the physical layer. In some examples, the UE 115 may receive first control information from the network entity 105 that includes a first PDU set ID associated with a set of different PDUs that collectively represent a data unit for decoding. The first control information may be included in DCI (e.g., scheduling DCI or activation DCI). Upon receiving the control information, the UE 115 may identify that a PDU is included in the set of different PDUs and determine whether to transmit or monitor for the PDU based on the PDU being included in the set of different PDUs. In one example, the UE 115 may not transmit or monitor for the PDU if the PDU is scheduled to be received after a time duration (e.g., PDB) or if the UE 115 receives second control information scheduling the UE to receive or monitor for PDUs associated with a second PDU set ID during a same time the UE 115 is to monitor for or receive the PDU. The method as described herein may enable a UE 115 to refrain from monitoring or transmitting one or more PDUs of a PDU set in some scenarios (e.g., when exceeding PDB) which may decrease processing power at the UE 115 and result in a more efficient use of resources.

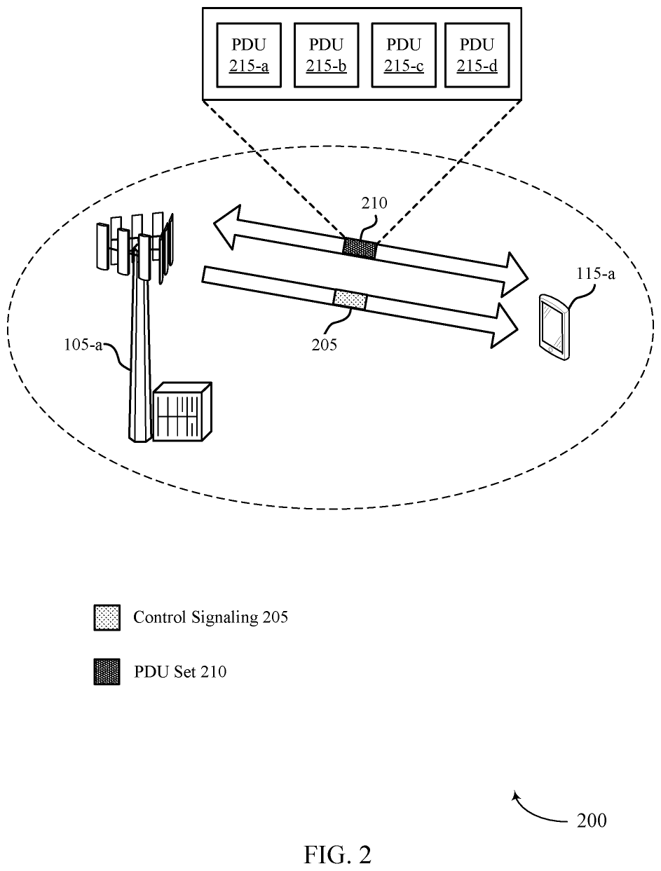

FIG. 2 illustrates an example of a wireless communications system 200 that supports physical layer association of extended reality data in accordance with one or more aspects of the present disclosure. In some examples, the wireless communications system 200 may implement aspects of a wireless communications system 100. For example, the wireless communications system 200 may include a network entity 105-a and a UE 115-a which may be examples of a network entity 105 and a UE 115 as described with reference to FIG. 1.

In some examples, the wireless communications system 200 may support extended reality (XR). XR may broadly refer to virtual reality (VR), augmented reality (AR), mixed reality (MR), or any other immersive technology. VR may allow for a user to be immersed in a virtual environment, AR may augment or add to the user's surrounding, and MR may implement aspects of both VR and AR. Examples of XR devices may include VR headsets or AR glasses. In the example of FIG. 2, the UE 115-a may be an example of an XR device.

To support XR, the network entity 105-a may transmit a series of data packets to the UE 115-a and the UE 115-a may collectively decode the series of data packets to obtain a video frame. In some examples, each data packet of the series may be known as a PDU 215 and the series of data packets that correspond to a same video frame may be known as a PDU set 210 or an application data unit (ADU). As an example, the network entity 105-a may transmit the PDU set 210 to the UE 115-a. As shown in FIG. 2, transmitting the PDU set 210 may include transmitting a PDU 215-a, a PDU 215-b, a PDU 215-c, and a PDU 215-d. That is, the PDU 215-a, the PDU 215-b, the PDU 215-c, and the PDU 215-d may collectively make up the PDU set 210.

In some examples, the network entity 105-a may schedule the UE 115-a to receive or transmit the PDU set 210 using dynamic scheduling or periodic scheduling. For dynamic scheduling, the UE 115-a may receive a dynamic grant (DG) in downlink control information (DCI) that includes an indication of a set of resources over which to transmit or receive the PDU set 210 (e.g., each PDU 215 of the PDU set 210). Alternatively, for periodic scheduling, the UE 115-a may be configured with sets of periodically repeating resources and receive an activation message in DCI that allows the UE 115-a to transmit or receive the PDU 215 (e.g., each PDU 215 of the PDU set 210) over one of the periodically repeating resource sets. The UE 115-a may utilize periodic scheduling for uplink or downlink. In uplink, the periodic scheduling may be referred to as semi-persistent scheduling (SPS) and in downlink, the periodic scheduling may be referred to as a configured grant (CG). Each instance of the periodically repeating resource sets may be known as an SPS occasion or a CG occasion (for SPS and CG, respectively) and only one PDU set 210 may be transmitted or received over each SPS occasion or CG occasion.

As described above, all PDUs 215 scheduled by a DG belong to the same PDU set 210 and all PDUs 215 on a same SPS occasion or CG occasion belong to the same PDU set 210. However, the network entity 105-a and the UE 115-a may be unaware of this correlation between the PDUs 215 and the PDU set 210 at the physical layer (e.g., topmost layer of the protocol stack). Such awareness may be beneficial in scenarios when transmission or reception of the PDU set 210 exceeds a packet delay budget (PDB). The PDB defines a threshold time that a data packet may be delayed between the UE 115-a and the network entity 105-a. The UE 115-a or the network entity 105-a may receive PDUs 215 transmitted after the PDB, but at the lower layers of the protocol stack, the data included in the PDUs 215 may be disregarded due to surpassing the PDB. Identifying the correlation between the PDUs 215 and the PDU set 210 at the physical layer may allow the network entity 105-a and the UE 115-a to refrain from receiving or transmitting PDUs 215 that surpass PDB which may reduce processing and power consumption at the UE 115-a or the network entity 105-a.

As described herein, the network entity 105-a or the UE 115-a may identify an association between PDUs 215 of a same PDU set 210. In some examples, the UE 115-a may receive control signaling 205 that includes a PDU set identifier (ID). The control signaling 205 may be an example of DCI that includes a DG (e.g., scheduling DCI) or DCI that include an indication to activate CG or SPS (e.g., activation DCI). If the UE 115-a receives the scheduling DCI, the PDU set ID corresponds to all PDUs 215 scheduled to be transmitted or received over the set of resources indicated by the DG in the scheduling DCI. If the UE 115-a receives the activation DCI, the PDU set ID corresponds to all PDUs 215 to be transmitted or received in the first SPS occasion or first CG occasion activated by the activation DCI.

In some examples, the PDU ID included in the control signaling may be valid for a validity duration. Upon receiving or transmitting a first PDU 215 (e.g., the PDU 215-a) corresponding to the PDU set ID, the UE 115-a may initiate a timer, where a duration of the timer may be equal to the validity duration. At expiration of the timer, the UE 115-a may not expect to receive or transmit PDUs 215 corresponding to the PDU set ID. As such, when the timer expires, the UE 115-a may refrain from monitoring or transmitting a PDU 215 corresponding to the PDU set ID. In addition, at expiration of the timer, the network entity 105-a may change or update the PDU set ID such that a subsequent scheduling DCI includes a different PDU set ID or such that PDUs 215 of a second SPS or CG occasion are associated with a different PDU set ID. In some examples, the validity duration may be equal to the PDB. Additionally or alternatively, the UE 115-a may refrain from monitoring or transmitting a PDU 215 corresponding to the PDU set ID if the UE receives second control signaling indicating a second PDU set ID different from the PDU set ID.

Further, the UE 115-a may jointly encode or decode PDUs 215 that correspond to a same PDU set ID on the physical layer. In some examples, a coding scheme used to jointly encode or decode the PDUs 215 may be a rateless code. A rateless code may be described as a code that can generate any number of encoded symbols from a given number of source symbols. Some examples of rateless codes may be Luby transform (LT) codes or Raptor codes. Physical layer rateless coding may reduce latency associated with communication between the physical layer and upper layers of the protocol stack.

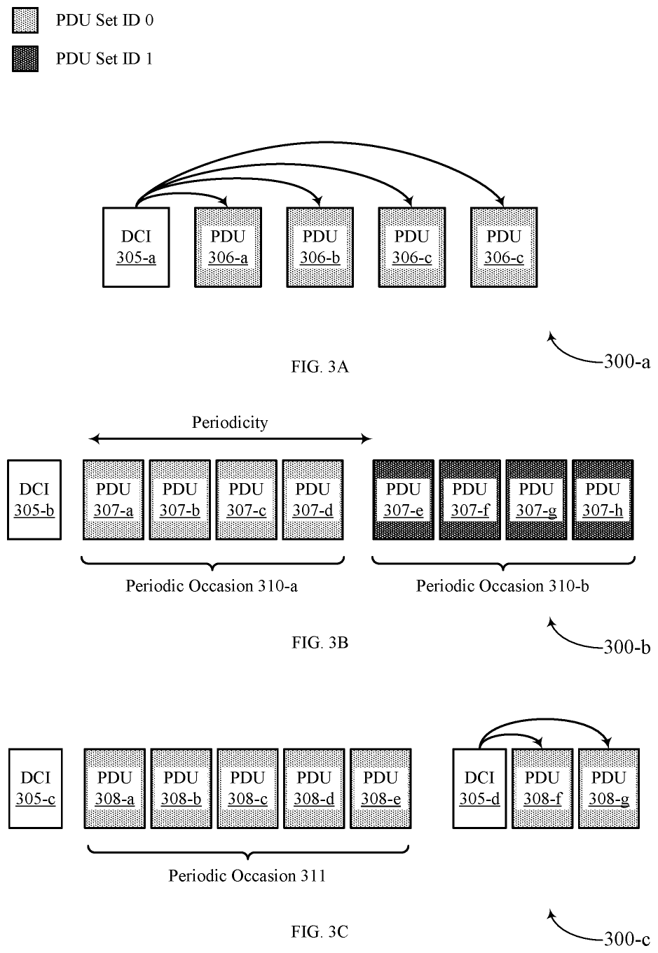

FIGS. 3A, 3B, and 3C illustrate examples of a scheduling scheme 300 (e.g., a scheduling scheme 300-a, a scheduling scheme 300-b, and a scheduling scheme 300-c) that supports physical layer association of extended reality data in accordance with one or more aspects of the present disclosure. In some examples, the scheduling scheme 300-a, the scheduling scheme 300-b, and the scheduling scheme 300-c may implement aspects of a wireless communications system 100 or a wireless communications system 200. For example, the scheduling scheme 300-a, the scheduling scheme 300-b, and the scheduling scheme 300-b may be implemented by a network entity or a UE which may be examples of a network entity 105 and a UE 115 as described with reference to FIGS. 1 and 2.

FIG. 3A illustrates an example of the network entity scheduling the UE to receive or transmit a PDU set using dynamic scheduling. In some examples, the UE may receive a DCI 305-a. The DCI 305-a may be an example of a scheduling DCI and include a DG that indicates a set of resources over which to transmit or receive a PDU 306-a, a PDU 306-b, a PDU 306-c, and a PDU 306-d. As described with reference to FIGS. 2, PDUs 306 scheduled by the same scheduling DCI (e.g., DCI 305-a) may correspond to a same PDU set. As such, the PDU 306-a, the PDU 306-b, the PDU 306-c, and the PDU 306-d may belong to the same PDU set.

Additionally, as described herein, the scheduling DCI 305-a may include a PDU set ID. The PDU set ID may function as indication to the UE that the PDU 306-a, the PDU 306-b, the PDU 306-c, and the PDU 306-d may belong to the same PDU set. In some examples, a PDU set ID bit field in the DCI may be defined for the PDU set ID. In such example, the PDU set ID bit field may include a single bit with a logic value of either 1 or 0. To indicate a transition to a different PDU set, the logic value of the bit included in the PDU set ID bit field may be changed or updated. For example, the DCI 305-a may include a PDU set ID bit field that includes a bit with a logic value of 0. Some time after receiving the DCI 305-a (e.g., after receiving the PDU 306-a), the UE may receive a second scheduling DCI and the second scheduling DCI may schedule the UE to receive or transmit PDUs that correspond to a second PDU set (e.g., different than the PDU set). As such, the second scheduling DCI may include a PDU set ID bit field that includes a bit with logic value of 1. The change in the logic value of the bit signals to the UE that the PDUs scheduled by the second scheduling DCI belongs to a different PDU set than the PDUs 306 scheduled by the DCI 305-a.

FIG. 3B illustrates an example of the network entity scheduling the UE to receive or transmit a PDU set using periodic scheduling. In some examples, the UE may receive a DCI 305-b. The DCI 305-b may be an example of an activation DCI and may indicate to activate an SPS or a CG configuration. As described with reference to FIGS. 2, PDUs 307 on a same periodic occasion 310 (e.g., an SPS occasion or a CG occasion) may correspond to a same PDU set. As such, PDUs 307 of the periodic occasion 310-a (e.g., a PDU 307-a, a PDU 307-b, a PDU 307-c, and a PDU 307-d) may belong to a first PDU set and PDUs 307 of the second periodic occasion 310-b (e.g., a PDU 307-e, a PDU 307-f, a PDU 307-g, and a PDU 307-h) may belong to a second PDU set.

Additionally, as described herein, the periodic DCI 305-b may include a PDU set ID. The PDU set ID may function as indication to the UE that the PDUs 307 of the first periodic occasion (e.g., the periodic occasion 310-a) may belong to the same PDU set. In some examples, a PDU set ID bit field in the DCI 305-b may be defined for the PDU set ID of the first periodic occasion. In such example, the PDU set ID bit field may include a single bit with a logic value of either 1 or 0. For example, the DCI 305-b may include a PDU set ID bit field that includes a bit with a logic value of 0. After transmitting or receiving the PDUs 307 during the periodic occasion 310-a, the UE may transmit or receive PDUs 307 during the periodic occasion 310-b. As such, before the periodic occasion 310-b, the UE may set (or assume) the PDU set ID of PDUs 307 during the periodic occasion 310-b to be a logic value of 1. In some examples, for each subsequent periodic occasion 310 (e.g., after the periodic occasion 310-b), the UE may invert the logic value of the bit.

FIG. 3C illustrates an example of the network entity scheduling the UE to receive or transmit a PDU set using both periodic scheduling and dynamic scheduling. That is, a portion of the PDUs of the PDU set may be scheduled using periodic scheduling and a remaining portion of the PDUs of the PDU set may be scheduled using dynamic scheduling or a portion of the PDU set may be scheduled using dynamic scheduling and a remaining portion of the PDUs of the PDU set may be scheduled using periodic scheduling. In some examples, a threshold number of slots that may be configured for SPS or a CG (e.g., a maximum number of slots per periodic occasion 310-c) may be five slots. Data included in a PDU set may span a minimum of 5 slots and a maximum of 15 slots with an average of 10 slots. As such, periodic scheduling may not provide enough slots for all PDUs of a PDU set and some of the PDUs of the PDU set may be scheduled via dynamic scheduling.

In one example, a PDU set may include a PDU 308-a, a PDU 308-b, a PDU 308-c, a PDU 308-d, a PDU 308-e, a PDU 308-f, and a PDU 308-g. In such example, the UE may receive a DCI 305-c. The DCI 305-c may be an example of an activation DCI and may indicate to transmit or receive the PDU set over the periodic occasion 311. As described above, the UE may transmit a threshold number of five PDUs 308 using periodic scheduling. As such, the UE may transmit or receive the PDU 308-a, the PDU 308-b, the PDU 308-c, the PDU 308-d, and the PDU 308-e during the periodic occasion 311. As for the remaining PDUs 308 of the PDU set, the UE may receive a DCI 305-d. The DCI 305-d may be an example of a scheduling DCI and may include a DG that indicates a set of resources over which to transmit or receive the remaining PDUs of the PDU set (e.g., the PDU 308-f and the PDU 306-g).

Additionally, as described herein, the DCI 305-c and the DCI 305-d may include a PDU set ID. The PDU set ID may function as indication to the UE that the PDUs 308 may belong to the same PDU set. In some examples, a PDU set ID bit field in the DCI 305-c and the DCI 305-d may be defined for the PDU set ID. In such example, the PDU set ID bit field may include a single bit with a logic value of either 1 or 0. Because the PDUs 308 scheduled by the DCI 305-c and the DCI 305-d belong to the same PDU set ID, the PDU set ID bit field in the DCI 305-c and the PDU set ID bit field in the DCI 305-d may include a bit with a same logic value (e.g., 0 or 1).

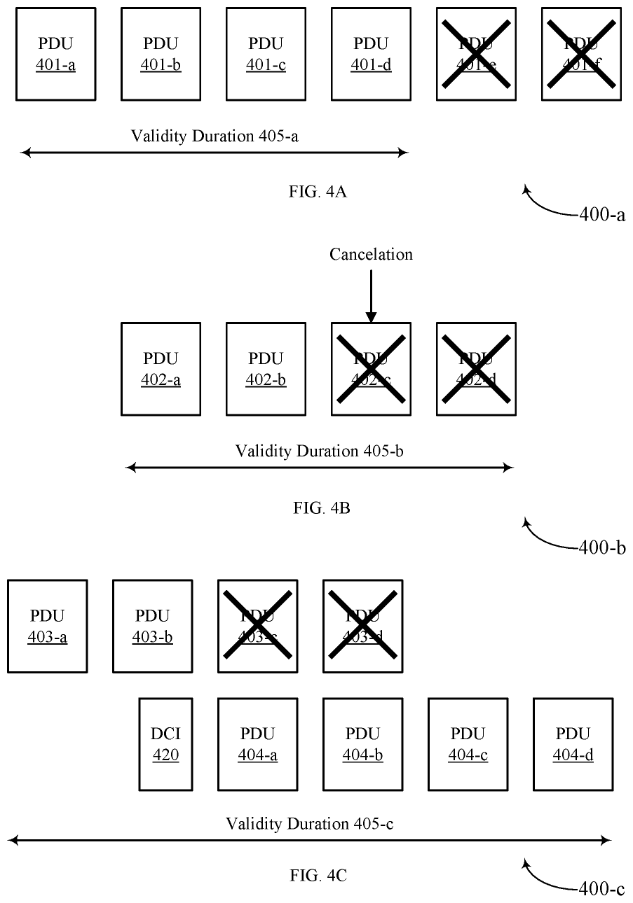

FIGS. 4A, 4B, and 4C illustrate examples of a cancellation scheme 400 (e.g., a cancellation scheme 400-a, a cancellation scheme 400-b, and a cancellation scheme 400-c) that supports physical layer association of extended reality data in accordance with one or more aspects of the present disclosure. In some examples, the cancellation scheme 400-a, the cancellation scheme 400-b, and the cancellation scheme 400-c may implement aspects of a wireless communications system 100 or a wireless communications system 200. For example, the cancellation scheme 400-a, the cancellation scheme 400-b, and the cancellation scheme 400-c may be implemented by a network entity and a UE which may be examples of a network entity 105 and a UE 115 as described with reference to FIGS. 1 and 2.

As described with reference to FIG. 2, PDUs associated with a same PDU set ID may be valid within a validity duration 405. In some examples, the UE may receive control signaling from the network entity configuring the UE with the validity duration 405. Further, the validity duration may be based on a PDB of XR video frame data. For example, the validity duration may be equal to the PDB. Upon receiving or transmitting a first PDU of a PDU set, the UE may initiate a timer that expires after the validity duration.

In some examples, the UE may receive control signaling scheduling the UE to transmit or receive a PDU set and include a corresponding PDU set ID. As illustrated in FIG. 4A, the PDU set may include a PDU 401-a, a PDU 401-b, a PDU 401-c, a PDU 401-d, a PDU 401-e and a PDU 401-f Upon receiving or transmitting the first PDU 401 of the PDU set (e.g., the PDU 401-a), the UE may initiate the timer and before expiration of the timer, the UE may subsequently receive or transmit the PDU 401-b, the PDU 401-c, and the PDU 401-d. That is, the PDU 401-a, the PDU 401-b, the PDU 401-c, and the PDU 401-d may be received or transmitted within the validity duration 405-a. After expiration of the timer, the UE may not expect to be scheduled with another PDU 401 of the PDU set. As such, after expiration of the timer, the UE may refrain from monitoring or transmitting PDUs 401 of the PDU set. That is, the UE may not receive or transmit the PDU 401-e and the PDU 401-f. Additionally, after expiration of the timer, the network entity may change or update the PDU set ID for new data scheduling.

In another example, a UE may cancel one or more PDUs 402 of a PDU set within a validity duration 405-b. As one example, the UE may receive cancellation signaling. The cancellation signaling may indicate a set of resources and the UE may cancel one or more PDUs 402 to be received or transmitted over resources that overlap the set of resources. In some examples, the UE may receive control signaling scheduling the UE to transmit or receive a PDU set and include a corresponding PDU set ID. As shown in FIG. 4B, the PDU set may include a PDU 402-a, a PDU 402-b, a PDU 402-c, and a PDU 402-d. Prior to or during transmission or reception of the PDU set, the UE may receive the cancellation signaling. The cancellation signaling may indicate a set of resources that overlaps with resources used to transmit or receive the PDU 402-c and as such the PDU 402-c may be canceled. That is, the UE may refrain from transmitting or monitoring for the PDU 402-c. Additionally, all subsequent PDUs 402 of the PDU set may be canceled. For example, the PDU 402-d may be canceled in addition to the PDU 402-c.

Alternatively, the UE may receive cancellation signaling that includes an indication of the PDU set ID and upon receiving the cancellation signaling, the UE may cancel one or more PDUs 402 that belong to the PDU set ID. In some examples, the time at which the UE receives the cancellation signaling may determine which PDUs 402 of the PDU set ID may be canceled. For example, the UE may receive the cancellation signaling after receiving or transmitting the PDU 402-b and prior to transmitting or receiving the PDU 402-c and may cancel the PDU 402-c based on receiving the cancellation signaling after receiving or transmitting the PDU 402-b and prior to transmitting or receiving the PDU 402-c. Additionally, the UE may cancel PDUs 402 subsequent to the PDU 402-c (e.g., the PDU 402-d).

In another example, the UE may cancel one or more PDUs 403 that belong to a first PDU set based on being scheduled to receive or transmit PDUs 404 that belong to a second PDU set during the validity duration 405-c of the first PDU set. In some examples, the UE may receive control signaling scheduling the UE to transmit or receive a first PDU set and include a corresponding first PDU set ID. In the example of FIG. 4C, a first PDU set may include a PDU 403-a, a PDU 403-b, a PDU 403-c, and a PDU 403-d. During or prior to transmission of the first PDU set, the UE may receive DCI 420. DCI 420 may schedule the UE to receive or transmit a second PDU set over a set of resources and may include a PDU set ID that corresponds to the second set of PDUs. As shown in FIG. 4C, the second PDU set may include a PDU 404-a, 404-b, 404-c, and 404-d and may correspond to a second PDU set ID. In some examples, the set of resources may overlap resources over which a PDU 403 is scheduled to be transmitted or received. For example, the set of resources may overlap resources over which the PDU 403-c and PDU 404-c are scheduled to be transmitted or received. In such example, the UE may cancel the PDU 403-c and the PDU 404-d and transmit or receive the second PDU set. That is, the UE may transmit the PDU 404-a, the PDU-b, the PDU 404-c, and the PDU 404-d over the set of resources within the validity duration 405-c.

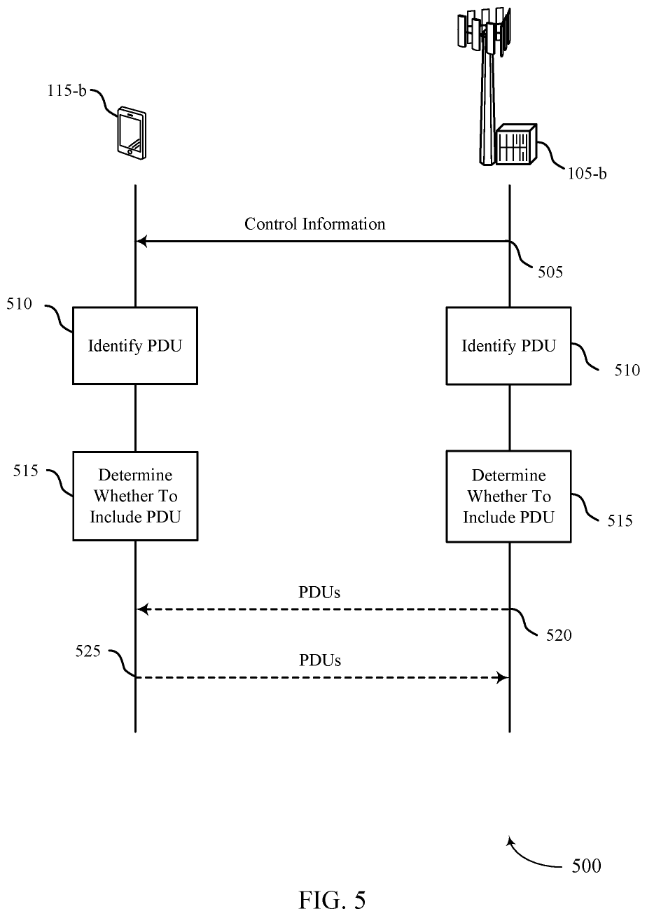

FIG. 5 illustrates an example of a process flow 500 that supports physical layer association of extended reality data in accordance with one or more aspects of the present disclosure. In some examples, the process flow 500 may be implemented by aspects of a wireless communications system 100 and a wireless communications system 200. For example, the process flow 500 may be implemented by a UE 115-b and a network entity 105-b which may be examples of a UE 115 and a network entity 105 as described with reference to FIGS. 1 and 2. Alternative examples of the following may be implemented, where some steps are performed in a different order than described or are not performed at all.

At 505, the UE 115-b may receive control information from the network entity 105-b. In some examples, the control information may include a first PDU set ID associated with a set of different PDUs that collectively represent a data unit for decoding. The control information may be included in a scheduling DCI (e.g., for dynamic scheduling) or an activation DCI (e.g., for periodic scheduling). In some examples, PDU set based scheduling may be enabled by a non-fallback DCI (e.g., DCI format 1_1 or DCI format 0_1) or a new DCI format may be defined for the PDU set based scheduling. In some examples, the UE 115-b may determine whether the DCI is for PDU set based scheduling based on a size of the DCI format. The new DCI format size may be different from other DCI format sizes. Alternatively or additionally, the UE 115-b may be configured with a CORESET or search space (SS) set for receiving PDU set based scheduling. If a PDU set based CORESET overlaps with a non-PDU set based CORESET, the UE 115-b may assume PDU set based scheduling.

At 510, the UE 115-b or the network entity 105-b may identify a PDU is a part of the set of different PDUs that correspond to the first PDU set ID based on the control information.

At 515, the UE 115-b or the network entity 105-b may determine whether to include the PDU in communications with the network entity 105-b based on the PDU being part of the set of different PDUs. That is, the UE 115-b may determine whether to receive the PDU from or transmit the PDU to the network entity 105-a.

At 520, for downlink, the UE 115-b may potentially monitor for one or more PDUs of the set of different PDUs. Alternatively, at 525, for uplink, the UE 115-b may potentially transmit one or more PDUs of the set of different PDUs. In some examples, the UE 115-b may encode or decode the set of different PDUs using an encoding scheme or a decoding scheme that includes joint encoding or joint decoding over multiple slots associated with the first PDU set ID. In some examples, a coding scheme used to decode or encode the set of different PDUs may include a rateless code.

In some examples, the UE 115-b may transmit or monitor for a first subset of the set of different PDUs during a time duration and identify that the PDU is part of second subset of different PDUs that are scheduled to be received or transmitted after the time duration. In such example, the UE 115-b may refrain from monitoring or transmitting the second subset of different PDUs based on the second subset of different PDUs being scheduled after the time duration.

In another example, the UE 115-b may transmit or monitor for a first subset of the set of different PDUs and receive, after transmitting or monitoring for the first subset of PDUs, second control information including a second PDU set ID. The UE 115-b may refrain from monitoring or transmitting a second subset of the set of different PDUs based on receiving the second control information.

In another example, the UE 115-b may transmit or monitor for a first subset of the set of different PDUs and receive, after transmitting or monitoring for the first subset of PDUs, a cancellation signal that indicates one or more PDUs of the set of different PDUs is canceled. The UE 115-b may refrain from monitoring or transmitting the second subset of PDUs based on receiving the cancellation signaling.

In another example, a first subset of the set of different PDUs may be scheduled using periodic scheduling and a second subset of the set of different PDUs may be scheduled using dynamic scheduling. In such example, the first control information may be included an activation DCI associated with a SPS scheduling configuration or a CG configuration. The activation DCI may schedule a first subset of the set of different PDUs. Additionally, the UE 115-b may receive second control information included in a scheduling DCI that includes the first PDU set ID and schedules a second subset of the set of different PDUs.

In some examples, if the control information is received in an activation DCI, the first PDU set ID may correspond to PDUs scheduled to be transmitted or received during a first SPS or CG occasion. For each subsequent SPS or CG occasions, the PDU set ID may be incremented by a value of one. In some examples, the PDU set ID may be represented by one bit. In such example, for each subsequent SPS or CG occasion, a logic value of the one bit may be inverted (e.g., from 0 to 1). In another example, the PDU set ID may be represented by two bits. A first bit may represent the PDU set ID and a second bit may represent whether the control information is for scheduling data associated with the PDU set ID. As one example, if a logic value of the second bit is 0, the control information may be for data associated with the PDU set ID and if the logic value of the second bit is 1, the control information may not be for data associated with the PDU set ID. If the control information is not for XR data, the UE 115-b or the network entity 105-b may disregard the first bit or the PDU set ID.

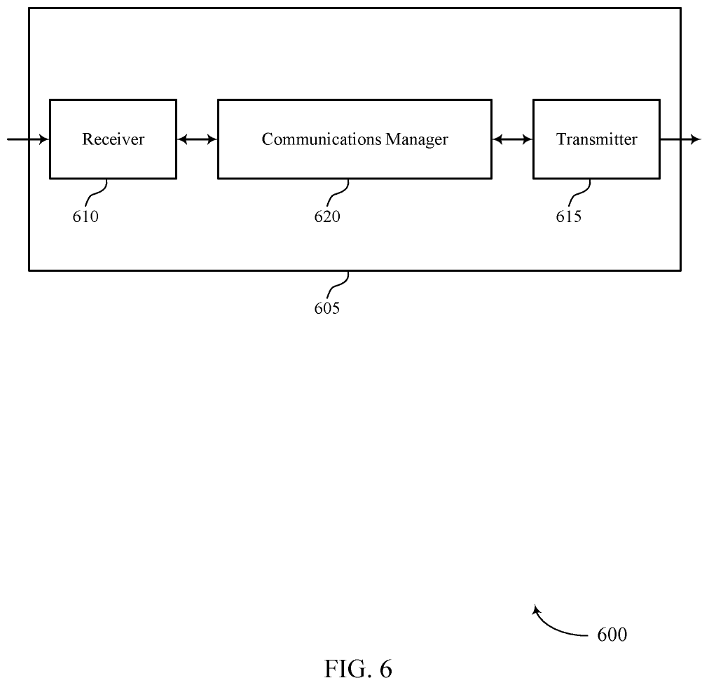

FIG. 6 shows a block diagram 600 of a device 605 that supports physical layer association of extended reality data in accordance with one or more aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to physical layer association of extended reality data). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to physical layer association of extended reality data). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of physical layer association of extended reality data as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication at a UE in accordance with examples as disclosed herein. For example, the communications manager 620 may be configured as or otherwise support a means for receiving first control information that includes a first PDU set ID associated with a set of different PDUs that collectively represent a data unit for decoding. The communications manager 620 may be configured as or otherwise support a means for identifying a PDU is a part of the set of different PDUs that corresponds to the first PDU set ID based on the first control information. The communications manager 620 may be configured as or otherwise support a means for determining whether to include the PDU in communications with a network entity, where the determining is based on the PDU being part of the set of different PDUs associated with the first PDU set ID.

By including or configuring the communications manager 620 in accordance with examples as described herein, the device 605 (e.g., a processor controlling or otherwise coupled with the receiver 610, the transmitter 615, the communications manager 620, or a combination thereof) may support techniques reduced processing, reduced power consumption, and more efficient utilization of communication resources.

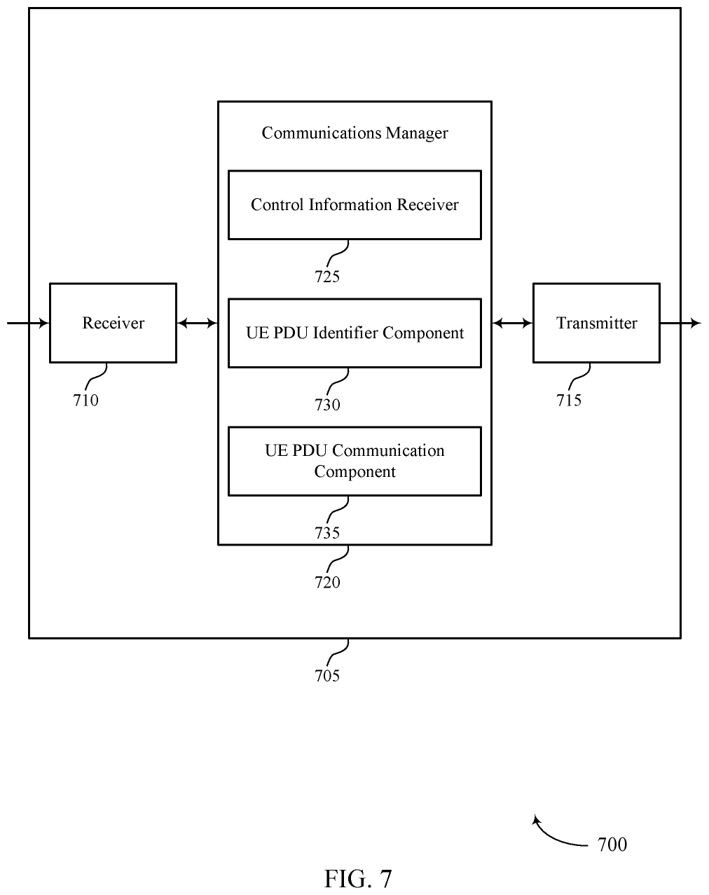

FIG. 7 shows a block diagram 700 of a device 705 that supports physical layer association of extended reality data in accordance with one or more aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to physical layer association of extended reality data). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to physical layer association of extended reality data). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of physical layer association of extended reality data as described herein. For example, the communications manager 720 may include a control information receiver 725, a UE PDU ID component 730, a UE PDU communication component 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at a UE in accordance with examples as disclosed herein. The control information receiver 725 may be configured as or otherwise support a means for receiving first control information that includes a first PDU set ID associated with a set of different PDUs that collectively represent a data unit for decoding. The UE PDU ID component 730 may be configured as or otherwise support a means for identifying a PDU is a part of the set of different PDUs that corresponds to the first PDU set ID based on the first control information. The UE PDU communication component 735 may be configured as or otherwise support a means for determining whether to include the PDU in communications with a network entity, where the determining is based on the PDU being part of the set of different PDUs associated with the first PDU set ID.

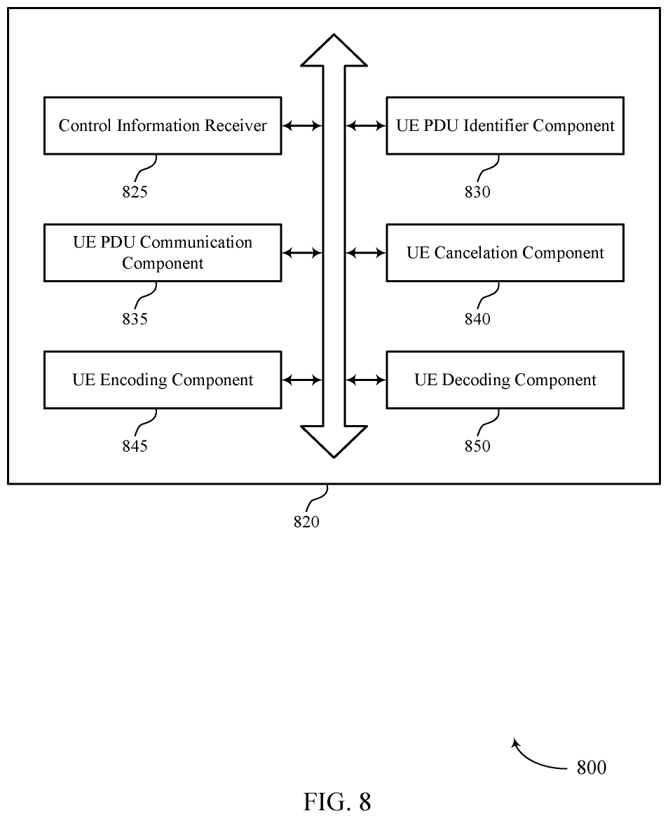

FIG. 8 shows a block diagram 800 of a communications manager 820 that supports physical layer association of extended reality data in accordance with one or more aspects of the present disclosure. The communications manager 820 may be an example of aspects of a communications manager 620, a communications manager 720, or both, as described herein. The communications manager 820, or various components thereof, may be an example of means for performing various aspects of physical layer association of extended reality data as described herein. For example, the communications manager 820 may include a control information receiver 825, a UE PDU ID component 830, a UE PDU communication component 835, a UE cancelation component 840, a UE encoding component 845, a UE decoding component 850, or any combination thereof. Each of these components may communicate, directly or indirectly, with one another (e.g., via one or more buses).

The communications manager 820 may support wireless communication at a UE in accordance with examples as disclosed herein. The control information receiver 825 may be configured as or otherwise support a means for receiving first control information that includes a first PDU set ID associated with a set of different PDUs that collectively represent a data unit for decoding. The UE PDU ID component 830 may be configured as or otherwise support a means for identifying a PDU is a part of the set of different PDUs that corresponds to the first PDU set ID based on the first control information. The UE PDU communication component 835 may be configured as or otherwise support a means for determining whether to include the PDU in communications with a network entity, where the determining is based on the PDU being part of the set of different PDUs associated with the first PDU set ID.

In some examples, the UE PDU communication component 835 may be configured as or otherwise support a means for transmitting, to the network entity, a first subset of the set of different PDUs during a first time duration. In some examples, the UE PDU ID component 830 may be configured as or otherwise support a means for identifying that the PDU is part of a second subset of the set of different PDUs that is scheduled to be transmitted after the first time duration. In some examples, the UE PDU communication component 835 may be configured as or otherwise support a means for refraining from transmitting, to the network entity, the second subset of the set of different PDUs based on the second subset being scheduled to be transmitted after the first time duration, where the PDU is not included in the communications with the network entity as a result of the PDU being in the second subset of the set of different PDUs.

In some examples, the first time duration is based on a PDB associated with the first PDU set ID.

In some examples, the UE PDU communication component 835 may be configured as or otherwise support a means for transmitting, to the network entity, a first subset of the set of different PDUs. In some examples, the control information receiver 825 may be configured as or otherwise support a means for receiving, after transmission of the first subset of the set of different PDUs and before transmission of a second subset of the set of different PDUs, second control information that includes a second PDU set ID that is different from the first PDU set ID. In some examples, the UE PDU communication component 835 may be configured as or otherwise support a means for refraining from transmitting, to the network entity, the second subset of the set of different PDUs based on the second control information being received before transmission of the second subset of the set of different PDUs, where the PDU is not included in the communications with the network entity as a result of the PDU being in the second subset of the set of different PDUs.

In some examples, the UE PDU communication component 835 may be configured as or otherwise support a means for transmitting, to the network entity, a first subset of the set of different PDUs. In some examples, the UE cancelation component 840 may be configured as or otherwise support a means for receiving, after transmission of the first subset of the set of different PDUs and before transmission of a second subset of the set of different PDUs, a cancelation signal that indicates that transmission of one or more PDUs of the set of different PDUs is canceled. In some examples, the UE PDU communication component 835 may be configured as or otherwise support a means for refraining from transmitting, to the network entity, the second subset of the set of different PDUs based on the cancelation signal being received before transmission of the second subset of the set of different PDUs, where the PDU is not included in the communications with the network entity as a result of the PDU being in the second subset of the set of different PDUs.

In some examples, the UE PDU communication component 835 may be configured as or otherwise support a means for receiving, from the network entity, a first subset of the set of different PDUs during a first time duration. In some examples, the UE PDU ID component 830 may be configured as or otherwise support a means for identifying that the PDU is part of a second subset of the set of different PDUs that is scheduled to be received after the first time duration. In some examples, the UE PDU communication component 835 may be configured as or otherwise support a means for refraining from monitoring for the second subset of the set of different PDUs based on the second subset being scheduled to be received after the first time duration, where the PDU is not included in the communications with the network entity as a result of the PDU being in the second subset of the set of different PDUs. In some examples, the first time duration is based on a PDB associated with the first PDU set ID.

In some examples, the UE PDU communication component 835 may be configured as or otherwise support a means for receiving, from the network entity, a first subset of the set of different PDUs. In some examples, the control information receiver 825 may be configured as or otherwise support a means for receiving, after receipt of the first subset of the set of different PDUs and before receipt of a second subset of the set of different PDUs, second control information that includes a second PDU set ID that is different from the first PDU set ID. In some examples, the UE PDU communication component 835 may be configured as or otherwise support a means for refraining from monitoring for the second subset of the set of different PDUs based on the second control information being received before receipt of the second subset of the set of different PDUs, where the PDU is not included in the communications with the network entity as a result of the PDU being in the second subset of the set of different PDUs.

In some examples, the UE PDU communication component 835 may be configured as or otherwise support a means for receiving, from the network entity, a first subset of the set of different PDUs. In some examples, the UE cancelation component 840 may be configured as or otherwise support a means for receiving, after receipt of the first subset of the set of different PDUs and before receipt of a second subset of the set of different PDUs, a cancelation signal that indicates that transmission by the network entity of one or more PDUs of the set of different PDUs is canceled. In some examples, the UE PDU communication component 835 may be configured as or otherwise support a means for refraining from monitoring for the second subset of the set of different PDUs based on the cancelation signal being received before receipt of the second subset of the set of different PDUs, where the PDU is not included in the communications with the network entity as a result of the PDU being in the second subset of the set of different PDUs.

In some examples, to support receiving the first control information that includes the first PDU set ID, the control information receiver 825 may be configured as or otherwise support a means for receiving the first control information in association with a SPS configuration or a CG configuration, where reception or transmission opportunities associated with the SPS configuration or the CG configuration, respectively, are scheduled in accordance with a minimum size of a PDU set, a first subset of the set of different PDUs being received or transmitted during the reception or transmission opportunities.

In some examples, the control information receiver 825 may be configured as or otherwise support a means for receiving, via a DG, second control information that includes the first PDU set ID, the second control information scheduling a second subset of the set of different PDUs for receipt or transmission, the second subset including one or more PDUs that were not included in the first subset.

In some examples, to support receiving the first control information that includes the first PDU set ID, the control information receiver 825 may be configured as or otherwise support a means for receiving the first control information via a DG.

In some examples, to support receiving the first control information that includes the first PDU set ID, the control information receiver 825 may be configured as or otherwise support a means for receiving the first control information via activation DCI that activates a SPS configuration or a CG configuration.

In some examples, the first PDU set ID in the first control information pertains to a first activated resource instance of the SPS configuration or of the CG configuration.

In some examples, subsequent activated resource instances of the SPS configuration or of the CG configuration that are subsequent to the first activated resource instance are associated with different PDU set IDs that have an incremented value with respect to previous activated resource instances.

In some examples, the UE encoding component 845 may be configured as or otherwise support a means for encoding the set of different PDUs based on the first PDU set ID, where an encoding scheme used for encoding the set of different PDUs includes joint encoding over multiple slots associated with the first PDU set ID, over resources scheduled via SPS and via DG associated with the first PDU set ID, over resources scheduled via CG and via DG associated with the first PDU set ID, or combinations thereof.

In some examples, the UE decoding component 850 may be configured as or otherwise support a means for decoding the set of different PDUs based on the first PDU set ID, where a decoding scheme used for decoding the set of different PDUs includes joint decoding over multiple slots associated with the first PDU set ID, over resources scheduled via SPS and via DG associated with the first PDU set ID, over resources scheduled via CG and via DG associated with the first PDU set ID, or combinations thereof.

In some examples, a coding scheme used to decode or encode the set of different PDUs includes a rateless code. In some examples, the first PDU set ID includes one bit with a logic value of one or zero. In some examples, the first PDU set ID includes more than one bit.

In some examples, PDU set-based transmission is enabled via a SPS configuration or a CG configuration, via a non-fallback DCI message, via a dedicated control resource set or search space designated for enabling PDU set-based transmission, or via a DCI message designated for enabling PDU set-based transmission.

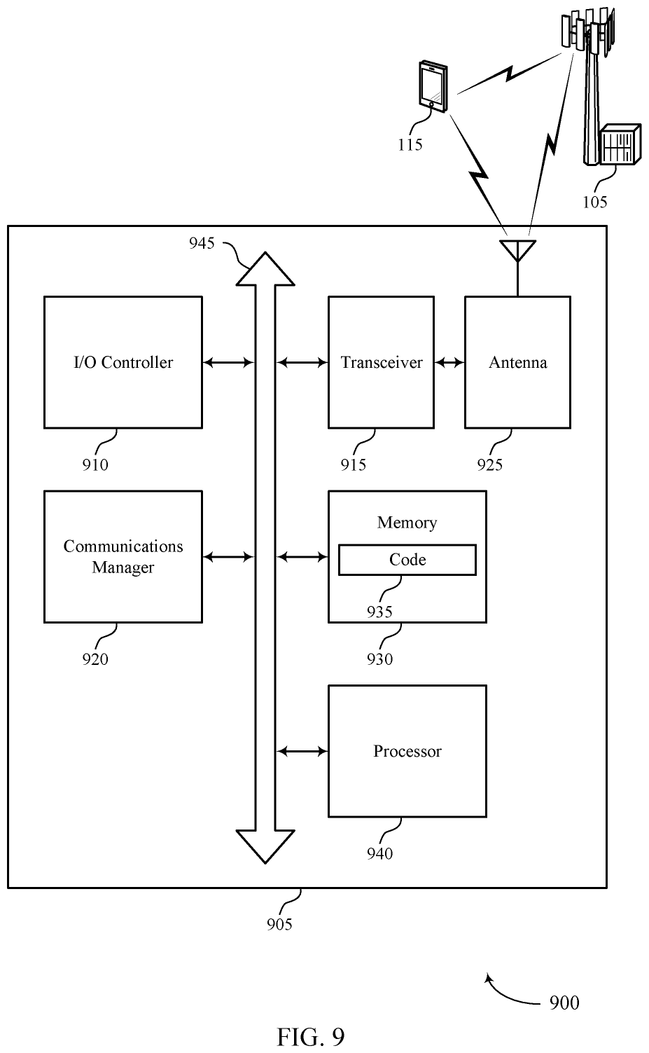

FIG. 9 shows a diagram of a system 900 including a device 905 that supports physical layer association of extended reality data in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting physical layer association of extended reality data). For example, the device 905 or a component of the device 905 may include a processor 940 and memory 930 coupled with or to the processor 940, the processor 940 and memory 930 configured to perform various functions described herein.

The communications manager 920 may support wireless communication at a UE in accordance with examples as disclosed herein. For example, the communications manager 920 may be configured as or otherwise support a means for receiving first control information that includes a first PDU set ID associated with a set of different PDUs that collectively represent a data unit for decoding. The communications manager 920 may be configured as or otherwise support a means for identifying a PDU is a part of the set of different PDUs that corresponds to the first PDU set ID based on the first control information. The communications manager 920 may be configured as or otherwise support a means for determining whether to include the PDU in communications with a network entity, where the determining is based on the PDU being part of the set of different PDUs associated with the first PDU set ID.

By including or configuring the communications manager 920 in accordance with examples as described herein, the device 905 may support techniques for improved user experience related to reduced processing, reduced power consumption, and more efficient utilization of communication resources.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of physical layer association of extended reality data as described herein, or the processor 940 and the memory 930 may be otherwise configured to perform or support such operations.

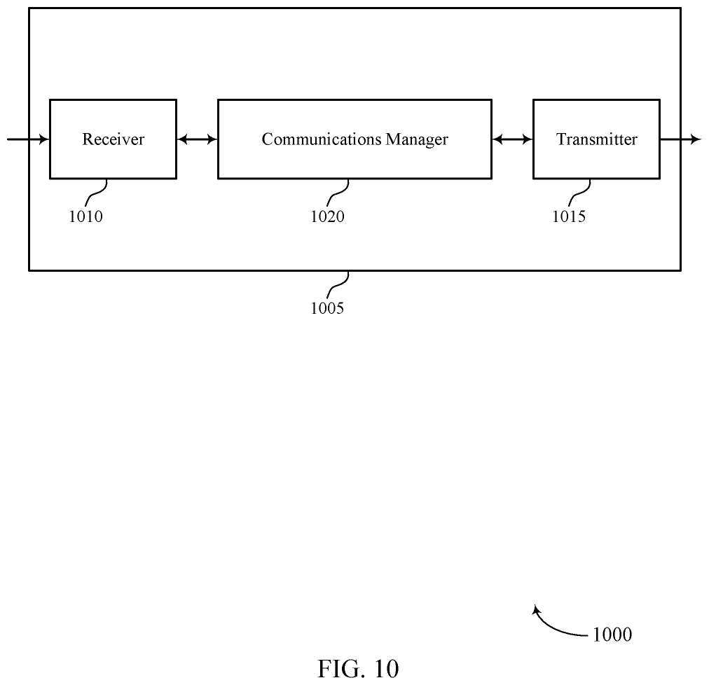

FIG. 10 shows a block diagram 1000 of a device 1005 that supports physical layer association of extended reality data in accordance with one or more aspects of the present disclosure. The device 1005 may be an example of aspects of a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations thereof or various components thereof may be examples of means for performing various aspects of physical layer association of extended reality data as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication at a network entity in accordance with examples as disclosed herein. For example, the communications manager 1020 may be configured as or otherwise support a means for transmitting first control information that includes a first PDU set ID associated with a set of different PDUs that collectively represent a data unit for decoding. The communications manager 1020 may be configured as or otherwise support a means for determining whether to include a PDU in communications with a UE, where the determining is based on the PDU being part of the set of different PDUs associated with the first PDU set ID.

By including or configuring the communications manager 1020 in accordance with examples as described herein, the device 1005 (e.g., a processor controlling or otherwise coupled with the receiver 1010, the transmitter 1015, the communications manager 1020, or a combination thereof) may support techniques for reduced processing, reduced power consumption, and more efficient utilization of communication resources.

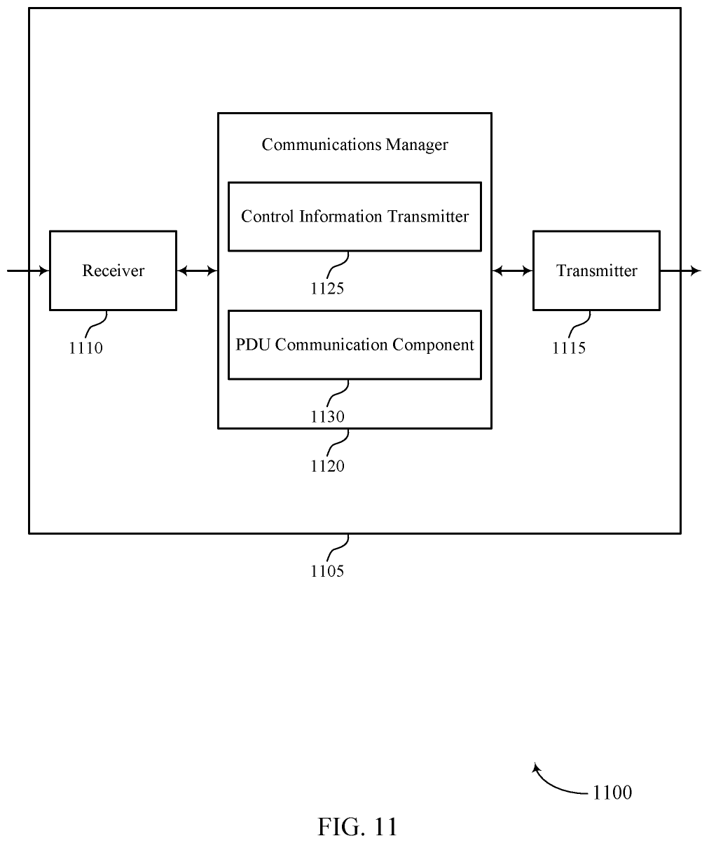

FIG. 11 shows a block diagram 1100 of a device 1105 that supports physical layer association of extended reality data in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of physical layer association of extended reality data as described herein. For example, the communications manager 1120 may include a control information transmitter 1125 a PDU communication component 1130, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication at a network entity in accordance with examples as disclosed herein. The control information transmitter 1125 may be configured as or otherwise support a means for transmitting first control information that includes a first PDU set ID associated with a set of different PDUs that collectively represent a data unit for decoding. The PDU communication component 1130 may be configured as or otherwise support a means for determining whether to include a PDU in communications with a UE, where the determining is based on the PDU being part of the set of different PDUs associated with the first PDU set ID.

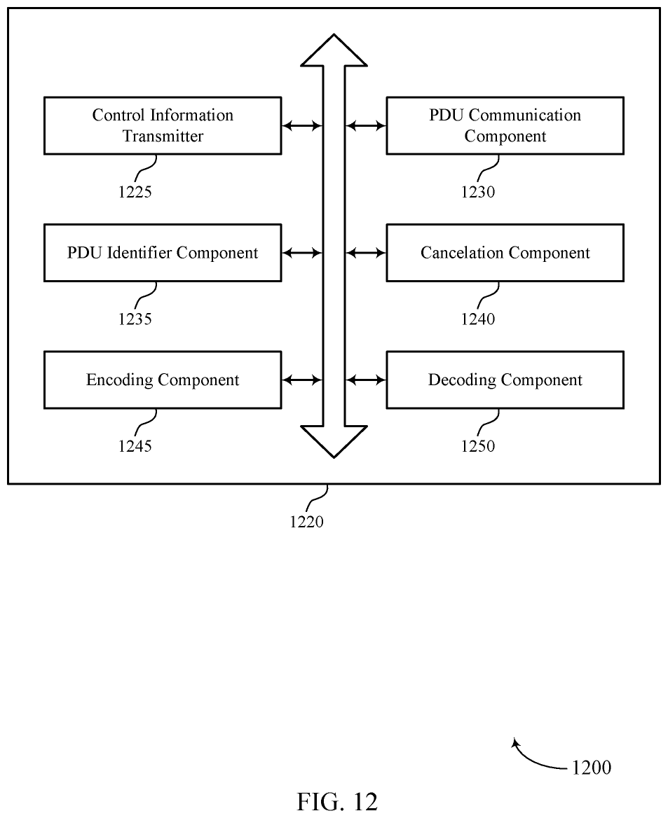

FIG. 12 shows a block diagram 1200 of a communications manager 1220 that supports physical layer association of extended reality data in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of physical layer association of extended reality data as described herein. For example, the communications manager 1220 may include a control information transmitter 1225, a PDU communication component 1230, a PDU ID component 1235, a cancelation component 1240, an encoding component 1245, a decoding component 1250, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communication at a network entity in accordance with examples as disclosed herein. The control information transmitter 1225 may be configured as or otherwise support a means for transmitting first control information that includes a first PDU set ID associated with a set of different PDUs that collectively represent a data unit for decoding. The PDU communication component 1230 may be configured as or otherwise support a means for determining whether to include a PDU in communications with a UE, where the determining is based on the PDU being part of the set of different PDUs associated with the first PDU set ID.

In some examples, the PDU communication component 1230 may be configured as or otherwise support a means for receiving, from the UE, a first subset of the set of different PDUs during a first time duration. In some examples, the PDU ID component 1235 may be configured as or otherwise support a means for identifying that the PDU is part of a second subset of the set of different PDUs that is scheduled to be received after the first time duration. In some examples, the PDU communication component 1230 may be configured as or otherwise support a means for refraining from monitoring for the second subset of the set of different PDUs based on the second subset being scheduled to be received after the first time duration, where the PDU is not included in the communications with the network entity as a result of the PDU being in the second subset of the set of different PDUs. In some examples, the first time duration is based on a PDB associated with the first PDU set ID.

In some examples, the PDU communication component 1230 may be configured as or otherwise support a means for receiving, from the UE, a first subset of the set of different PDUs. In some examples, the control information transmitter 1225 may be configured as or otherwise support a means for transmitting, after receipt of the first subset of the set of different PDUs and before receipt of a second subset of the set of different PDUs, second control information that includes a second PDU set ID that is different from the first PDU set ID. In some examples, the PDU communication component 1230 may be configured as or otherwise support a means for refraining from monitoring for the second subset of the set of different PDUs based on the second control information being transmitted before receipt of the second subset of the set of different PDUs, where the PDU is not included in the communications with the network entity as a result of the PDU being in the second subset of the set of different PDUs.

In some examples, the PDU communication component 1230 may be configured as or otherwise support a means for receiving, from the UE, a first subset of the set of different PDUs. In some examples, the cancelation component 1240 may be configured as or otherwise support a means for transmitting, after receipt of the first subset of the set of different PDUs and before receipt of a second subset of the set of different PDUs, a cancelation signal that indicates that transmission of one or more PDUs by the UE of the set of different PDUs is canceled. In some examples, the PDU communication component 1230 may be configured as or otherwise support a means for refraining from monitoring for the second subset of the set of different PDUs based on the cancelation signal being transmitted before receipt of the second subset of the set of different PDUs, where the PDU is not included in the communications with the network entity as a result of the PDU being in the second subset of the set of different PDUs.

In some examples, the PDU communication component 1230 may be configured as or otherwise support a means for transmitting, to the UE, a first subset of the set of different PDUs during a first time duration. In some examples, the PDU ID component 1235 may be configured as or otherwise support a means for identifying that the PDU is part of a second subset of the set of different PDUs that is scheduled to be transmitted after the first time duration. In some examples, the PDU communication component 1230 may be configured as or otherwise support a means for refraining from transmitting, to the UE, the second subset of the set of different PDUs based on the second subset being scheduled to be transmitted after the first time duration, where the PDU is not included in the communications with the network entity as a result of the PDU being in the second subset of the set of different PDUs. In some examples, the first time duration is based on a PDB associated with the first PDU set ID.

In some examples, the PDU communication component 1230 may be configured as or otherwise support a means for transmitting, to the UE, a first subset of the set of different PDUs. In some examples, the control information transmitter 1225 may be configured as or otherwise support a means for transmitting, after transmission of the first subset of the set of different PDUs and before transmission of a second subset of the set of different PDUs, second control information that includes a second PDU set ID that is different from the first PDU set ID. In some examples, the PDU communication component 1230 may be configured as or otherwise support a means for refraining from transmitting, to the UE, the second subset of the set of different PDUs based on the second control information being transmitted before transmission of the second subset of the set of different PDUs, where the PDU is not included in the communications with the network entity as a result of the PDU being in the second subset of the set of different PDUs.

In some examples, the PDU communication component 1230 may be configured as or otherwise support a means for transmitting, to the UE, a first subset of the set of different PDUs. In some examples, the cancelation component 1240 may be configured as or otherwise support a means for transmitting, after transmission of the first subset of the set of different PDUs and before transmission of a second subset of the set of different PDUs, a cancelation signal that indicates that transmission by the network entity of one or more PDUs of the set of different PDUs is canceled. In some examples, the PDU communication component 1230 may be configured as or otherwise support a means for refraining from transmitting, to the UE, the second subset of the set of different PDUs based on the cancelation signal being transmitted before transmission of the second subset of the set of different PDUs, where the PDU is not included in the communications with the network entity as a result of the PDU being in the second subset of the set of different PDUs.

In some examples, to support transmitting the first control information that includes the first PDU set ID, the control information transmitter 1225 may be configured as or otherwise support a means for transmitting the first control information in association with a SPS configuration or a CG configuration, where reception or transmission opportunities associated with the SPS configuration or the CG configuration, respectively, are scheduled in accordance with a minimum size of a PDU set, a first subset of the set of different PDUs being received or transmitted during the reception or transmission opportunities.

In some examples, the control information transmitter 1225 may be configured as or otherwise support a means for transmitting, via a DG, second control information that includes the first PDU set ID, the second control information scheduling a second subset of the set of different PDUs for receipt or transmission, the second subset including one or more PDUs that were not included in the first subset.

In some examples, to support transmitting the first control information that includes the first PDU set ID, the control information transmitter 1225 may be configured as or otherwise support a means for transmitting the first control information via a DG.

In some examples, to support transmitting the first control information that includes the first PDU set ID, the control information transmitter 1225 may be configured as or otherwise support a means for transmitting the first control information via activation DCI that activates a SPS configuration or a CG configuration. In some examples, the first PDU set ID in the first control information pertains to a first activated resource instance of the SPS configuration or of the CG configuration.

In some examples, subsequent activated resource instances of the SPS configuration or of the CG configuration that are subsequent to the first activated resource instance are associated with different PDU set IDs that have an incremented value with respect to previous activated resource instances.

In some examples, the encoding component 1245 may be configured as or otherwise support a means for encoding the set of different PDUs based on the first PDU set ID, where an encoding scheme used for encoding the set of different PDUs includes joint encoding over multiple slots associated with the first PDU set ID, over resources scheduled via SPS and via DG associated with the first PDU set ID, over resources scheduled via CG and via DG associated with the first PDU set ID, or combinations thereof.

In some examples, the decoding component 1250 may be configured as or otherwise support a means for decoding the set of different PDUs based on the first PDU set ID, where a decoding scheme used for decoding the set of different PDUs includes joint decoding over multiple slots associated with the first PDU set ID, over resources scheduled via SPS and via DG associated with the first PDU set ID, over resources scheduled via CG and via DG associated with the first PDU set ID, or combinations thereof.

In some examples, a coding scheme used to decode or encode the set of different PDUs includes a rateless code. In some examples, the first PDU set ID includes one bit with a logic value of one or zero. In some examples, the first PDU set ID includes more than one bit.

In some examples, PDU set-based transmission is enabled via a SPS configuration or a CG configuration, via a non-fallback DCI message, via a dedicated control resource set or search space designated for enabling PDU set-based transmission, or via a DCI message designated for enabling PDU set-based transmission.

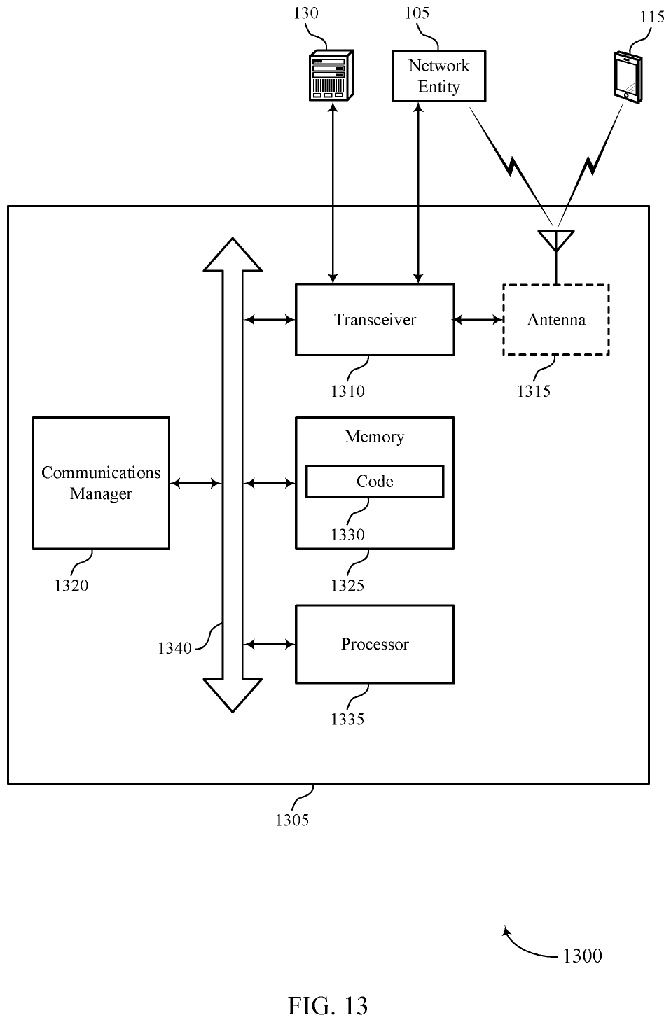

FIG. 13 shows a diagram of a system 1300 including a device 1305 that supports physical layer association of extended reality data in accordance with one or more aspects of the present disclosure. The device 1305 may be an example of or include the components of a device 1005, a device 1105, or a network entity 105 as described herein. The device 1305 may communicate with one or more network entities 105, one or more UEs 115, or any combination thereof, which may include communications over one or more wired interfaces, over one or more wireless interfaces, or any combination thereof. The device 1305 may include components that support outputting and obtaining communications, such as a communications manager 1320, a transceiver 1310, an antenna 1315, a memory 1325, code 1330, and a processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. The transceiver 1310, or the transceiver 1310 and one or more antennas 1315 or wired interfaces, where applicable, may be an example of a transmitter 1015, a transmitter 1115, a receiver 1010, a receiver 1110, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 1325 may include RAM and ROM. The memory 1325 may store computer-readable, computer-executable code 1330 including instructions that, when executed by the processor 1335, cause the device 1305 to perform various functions described herein. The code 1330 may be stored in a non-transitory computer-readable medium such as system memory or another type of memory. In some cases, the code 1330 may not be directly executable by the processor 1335 but may cause a computer (e.g., when compiled and executed) to perform functions described herein. In some cases, the memory 1325 may contain, among other things, a BIOS which may control basic hardware or software operation such as the interaction with peripheral components or devices.

The processor 1335 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1335 may be configured to operate a memory array using a memory controller. In some other cases, a memory controller may be integrated into the processor 1335. The processor 1335 may be configured to execute computer-readable instructions stored in a memory (e.g., the memory 1325) to cause the device 1305 to perform various functions (e.g., functions or tasks supporting physical layer association of extended reality data). For example, the device 1305 or a component of the device 1305 may include a processor 1335 and memory 1325 coupled with the processor 1335, the processor 1335 and memory 1325 configured to perform various functions described herein. The processor 1335 may be an example of a cloud-computing platform (e.g., one or more physical nodes and supporting software such as operating systems, virtual machines, or container instances) that may host the functions (e.g., by executing code 1330) to perform the functions of the device 1305.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the memory 1325, the code 1330, and the processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with other network entities 105, and may include a controller or scheduler for controlling communications with UEs 115 in cooperation with other network entities 105. In some examples, the communications manager 1320 may support an X2 interface within an LTE/LTE-A wireless communications network technology to provide communication between network entities 105.

The communications manager 1320 may support wireless communication at a network entity in accordance with examples as disclosed herein. For example, the communications manager 1320 may be configured as or otherwise support a means for transmitting first control information that includes a first PDU set ID associated with a set of different PDUs that collectively represent a data unit for decoding. The communications manager 1320 may be configured as or otherwise support a means for determining whether to include a PDU in communications with a UE, where the determining is based on the PDU being part of the set of different PDUs associated with the first PDU set ID.

By including or configuring the communications manager 1320 in accordance with examples as described herein, the device 1305 may support techniques for reduced latency, improved user experience related to reduced processing, reduced power consumption, and more efficient utilization of communication resources.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the processor 1335, the memory 1325, the code 1330, the transceiver 1310, or any combination thereof. For example, the code 1330 may include instructions executable by the processor 1335 to cause the device 1305 to perform various aspects of physical layer association of extended reality data as described herein, or the processor 1335 and the memory 1325 may be otherwise configured to perform or support such operations.

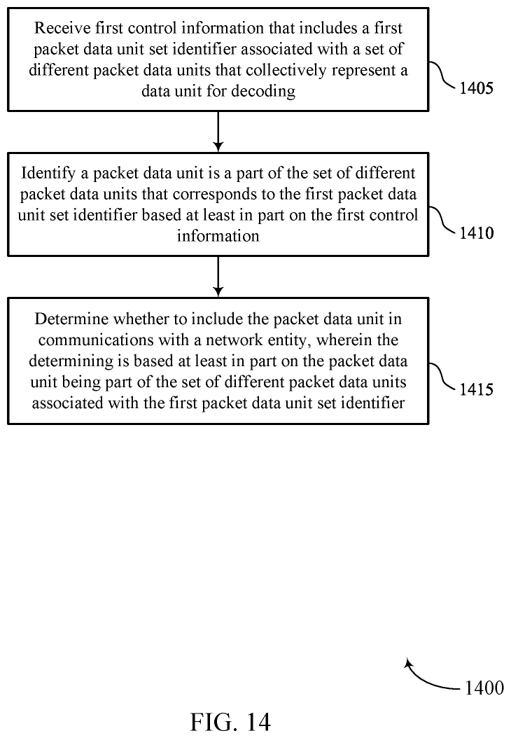

FIG. 14 shows a flowchart illustrating a method 1400 that supports physical layer association of extended reality data in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include receiving first control information that includes a first PDU set ID associated with a set of different PDUs that collectively represent a data unit for decoding. The operations of 1405 may be performed in accordance with examples as disclosed herein. In some examples, aspects of the operations of 1405 may be performed by a control information receiver 825 as described with reference to FIG. 8.

At 1410, the method may include identifying a PDU is a part of the set of different PDUs that corresponds to the first PDU set ID based on the first control information. The operations of 1410 may be performed in accordance with examples as disclosed herein. In some examples, aspects of the operations of 1410 may be performed by a UE PDU ID component 830 as described with reference to FIG. 8.

At 1415, the method may include determining whether to include the PDU in communications with a network entity, where the determining is based on the PDU being part of the set of different PDUs associated with the first PDU set ID. The operations of 1415 may be performed in accordance with examples as disclosed herein. In some examples, aspects of the operations of 1415 may be performed by a UE PDU communication component 835 as described with reference to FIG. 8.

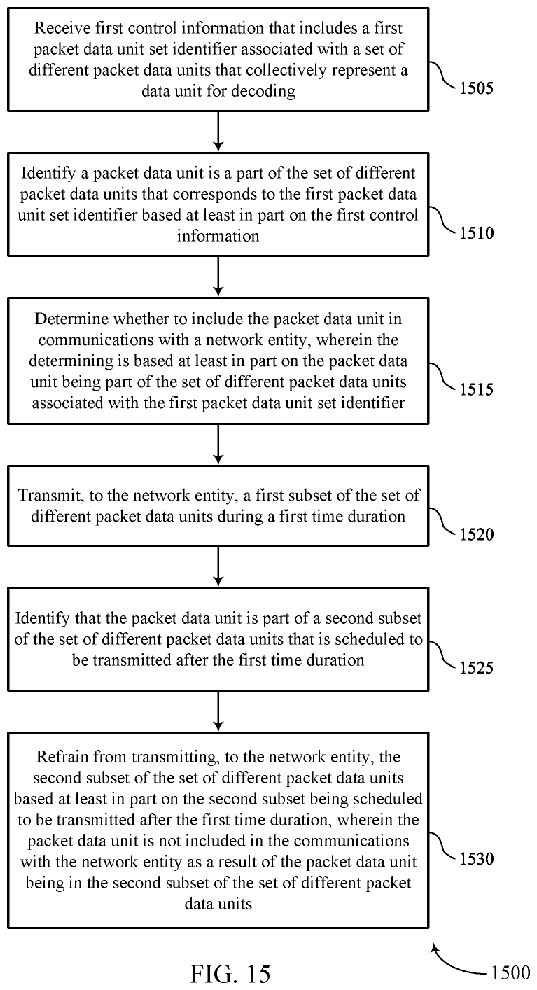

FIG. 15 shows a flowchart illustrating a method 1500 that supports physical layer association of extended reality data in accordance with one or more aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1505, the method may include receiving first control information that includes a first PDU set ID associated with a set of different PDUs that collectively represent a data unit for decoding. The operations of 1505 may be performed in accordance with examples as disclosed herein. In some examples, aspects of the operations of 1505 may be performed by a control information receiver 825 as described with reference to FIG. 8.

At 1510, the method may include identifying a PDU is a part of the set of different PDUs that corresponds to the first PDU set ID based on the first control information. The operations of 1510 may be performed in accordance with examples as disclosed herein. In some examples, aspects of the operations of 1510 may be performed by a UE PDU ID component 830 as described with reference to FIG. 8.

At 1515, the method may include determining whether to include the PDU in communications with a network entity, where the determining is based on the PDU being part of the set of different PDUs associated with the first PDU set ID. The operations of 1515 may be performed in accordance with examples as disclosed herein. In some examples, aspects of the operations of 1515 may be performed by a UE PDU communication component 835 as described with reference to FIG. 8.

At 1520, the method may include transmitting, to the network entity, a first subset of the set of different PDUs during a first time duration. The operations of 1520 may be performed in accordance with examples as disclosed herein. In some examples, aspects of the operations of 1520 may be performed by a UE PDU communication component 835 as described with reference to FIG. 8.

At 1525, the method may include identifying that the PDU is part of a second subset of the set of different PDUs that is scheduled to be transmitted after the first time duration. The operations of 1525 may be performed in accordance with examples as disclosed herein. In some examples, aspects of the operations of 1525 may be performed by a UE PDU ID component 830 as described with reference to FIG. 8.

At 1530, the method may include refraining from transmitting, to the network entity, the second subset of the set of different PDUs based on the second subset being scheduled to be transmitted after the first time duration, where the PDU is not included in the communications with the network entity as a result of the PDU being in the second subset of the set of different PDUs. The operations of 1530 may be performed in accordance with examples as disclosed herein. In some examples, aspects of the operations of 1530 may be performed by a UE PDU communication component 835 as described with reference to FIG. 8.

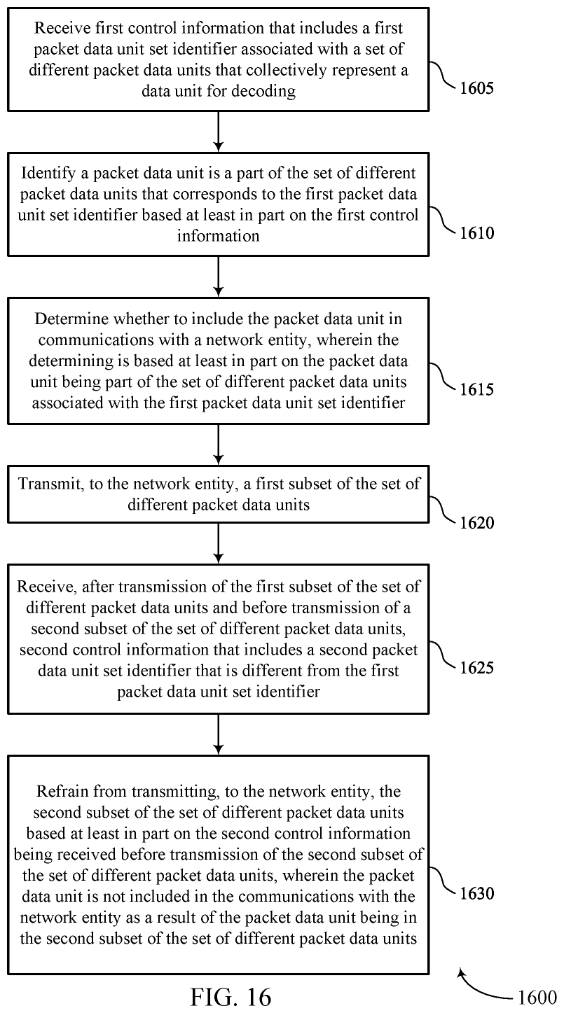

FIG. 16 shows a flowchart illustrating a method 1600 that supports physical layer association of extended reality data in accordance with one or more aspects of the present disclosure. The operations of the method 1600 may be implemented by a UE or its components as described herein. For example, the operations of the method 1600 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1605, the method may include receiving first control information that includes a first PDU set ID associated with a set of different PDUs that collectively represent a data unit for decoding. The operations of 1605 may be performed in accordance with examples as disclosed herein. In some examples, aspects of the operations of 1605 may be performed by a control information receiver 825 as described with reference to FIG. 8.

At 1610, the method may include identifying a PDU is a part of the set of different PDUs that corresponds to the first PDU set ID based on the first control information. The operations of 1610 may be performed in accordance with examples as disclosed herein. In some examples, aspects of the operations of 1610 may be performed by a UE PDU ID component 830 as described with reference to FIG. 8.

At 1615, the method may include determining whether to include the PDU in communications with a network entity, where the determining is based on the PDU being part of the set of different PDUs associated with the first PDU set ID. The operations of 1615 may be performed in accordance with examples as disclosed herein. In some examples, aspects of the operations of 1615 may be performed by a UE PDU communication component 835 as described with reference to FIG. 8.

At 1620, the method may include transmitting, to the network entity, a first subset of the set of different PDUs. The operations of 1620 may be performed in accordance with examples as disclosed herein. In some examples, aspects of the operations of 1620 may be performed by a UE PDU communication component 835 as described with reference to FIG. 8.

At 1625, the method may include receiving, after transmission of the first subset of the set of different PDUs and before transmission of a second subset of the set of different PDUs, second control information that includes a second PDU set ID that is different from the first PDU set ID. The operations of 1625 may be performed in accordance with examples as disclosed herein. In some examples, aspects of the operations of 1625 may be performed by a control information receiver 825 as described with reference to FIG. 8.

At 1630, the method may include refraining from transmitting, to the network entity, the second subset of the set of different PDUs based on the second control information being received before transmission of the second subset of the set of different PDUs, where the PDU is not included in the communications with the network entity as a result of the PDU being in the second subset of the set of different PDUs. The operations of 1630 may be performed in accordance with examples as disclosed herein. In some examples, aspects of the operations of 1630 may be performed by a UE PDU communication component 835 as described with reference to FIG. 8.

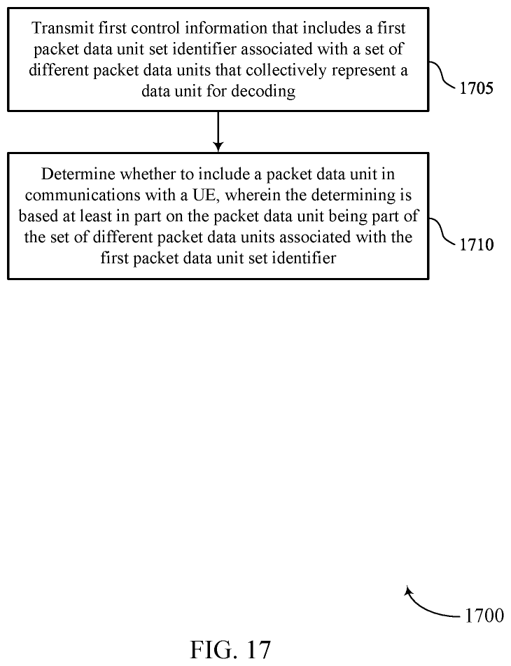

FIG. 17 shows a flowchart illustrating a method 1700 that supports physical layer association of extended reality data in accordance with one or more aspects of the present disclosure. The operations of the method 1700 may be implemented by a network entity or its components as described herein. For example, the operations of the method 1700 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1705, the method may include transmitting first control information that includes a first PDU set ID associated with a set of different PDUs that collectively represent a data unit for decoding. The operations of 1705 may be performed in accordance with examples as disclosed herein. In some examples, aspects of the operations of 1705 may be performed by a control information transmitter 1225 as described with reference to FIG. 12.

At 1710, the method may include determining whether to include a PDU in communications with a UE, where the determining is based on the PDU being part of the set of different PDUs associated with the first PDU set ID. The operations of 1710 may be performed in accordance with examples as disclosed herein. In some examples, aspects of the operations of 1710 may be performed by a PDU communication component 1230 as described with reference to FIG. 12.

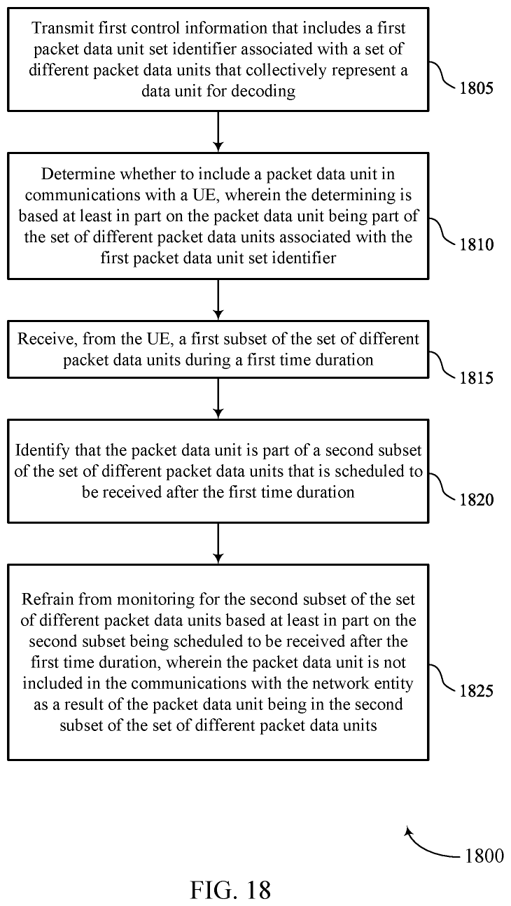

FIG. 18 shows a flowchart illustrating a method 1800 that supports physical layer association of extended reality data in accordance with one or more aspects of the present disclosure. The operations of the method 1800 may be implemented by a network entity or its components as described herein. For example, the operations of the method 1800 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1805, the method may include transmitting first control information that includes a first PDU set ID associated with a set of different PDUs that collectively represent a data unit for decoding. The operations of 1805 may be performed in accordance with examples as disclosed herein. In some examples, aspects of the operations of 1805 may be performed by a control information transmitter 1225 as described with reference to FIG. 12.

At 1810, the method may include determining whether to include a PDU in communications with a UE, where the determining is based on the PDU being part of the set of different PDUs associated with the first PDU set ID. The operations of 1810 may be performed in accordance with examples as disclosed herein. In some examples, aspects of the operations of 1810 may be performed by a PDU communication component 1230 as described with reference to FIG. 12.

At 1815, the method may include receiving, from the UE, a first subset of the set of different PDUs during a first time duration. The operations of 1815 may be performed in accordance with examples as disclosed herein. In some examples, aspects of the operations of 1815 may be performed by a PDU communication component 1230 as described with reference to FIG. 12.

At 1820, the method may include identifying that the PDU is part of a second subset of the set of different PDUs that is scheduled to be received after the first time duration. The operations of 1820 may be performed in accordance with examples as disclosed herein. In some examples, aspects of the operations of 1820 may be performed by a PDU ID component 1235 as described with reference to FIG. 12.

At 1825, the method may include refraining from monitoring for the second subset of the set of different PDUs based on the second subset being scheduled to be received after the first time duration, where the PDU is not included in the communications with the network entity as a result of the PDU being in the second subset of the set of different PDUs. The operations of 1825 may be performed in accordance with examples as disclosed herein. In some examples, aspects of the operations of 1825 may be performed by a PDU communication component 1230 as described with reference to FIG. 12.

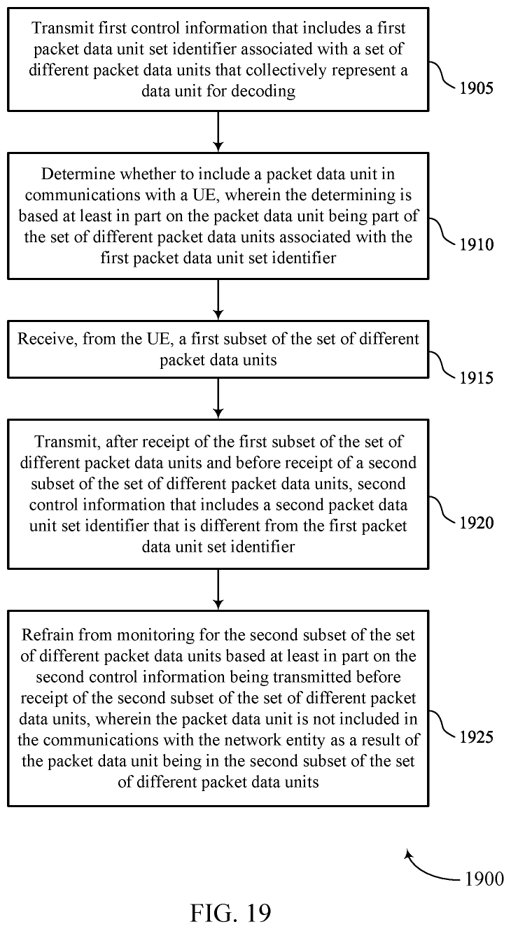

FIG. 19 shows a flowchart illustrating a method 1900 that supports physical layer association of extended reality data in accordance with one or more aspects of the present disclosure. The operations of the method 1900 may be implemented by a network entity or its components as described herein. For example, the operations of the method 1900 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1905, the method may include transmitting first control information that includes a first PDU set ID associated with a set of different PDUs that collectively represent a data unit for decoding. The operations of 1905 may be performed in accordance with examples as disclosed herein. In some examples, aspects of the operations of 1905 may be performed by a control information transmitter 1225 as described with reference to FIG. 12.

At 1910, the method may include determining whether to include a PDU in communications with a UE, where the determining is based on the PDU being part of the set of different PDUs associated with the first PDU set ID. The operations of 1910 may be performed in accordance with examples as disclosed herein. In some examples, aspects of the operations of 1910 may be performed by a PDU communication component 1230 as described with reference to FIG. 12.

At 1915, the method may include receiving, from the UE, a first subset of the set of different PDUs. The operations of 1915 may be performed in accordance with examples as disclosed herein. In some examples, aspects of the operations of 1915 may be performed by a PDU communication component 1230 as described with reference to FIG. 12.

At 1920, the method may include transmitting, after receipt of the first subset of the set of different PDUs and before receipt of a second subset of the set of different PDUs, second control information that includes a second PDU set ID that is different from the first PDU set ID. The operations of 1920 may be performed in accordance with examples as disclosed herein. In some examples, aspects of the operations of 1920 may be performed by a control information transmitter 1225 as described with reference to FIG. 12.

At 1925, the method may include refraining from monitoring for the second subset of the set of different PDUs based on the second control information being transmitted before receipt of the second subset of the set of different PDUs, where the PDU is not included in the communications with the network entity as a result of the PDU being in the second subset of the set of different PDUs. The operations of 1925 may be performed in accordance with examples as disclosed herein. In some examples, aspects of the operations of 1925 may be performed by a PDU communication component 1230 as described with reference to FIG. 12.

The following provides an overview of aspects of the present disclosure:
Aspect 1: A method for wireless communication at a UE, comprising: receiving first control information that includes a first PDU set ID associated with a set of different PDUs that collectively represent a data unit for decoding; identifying a PDU is a part of the set of different PDUs that corresponds to the first PDU set ID based at least in part on the first control information; and determining whether to include the PDU in communications with a network entity, wherein the determining is based at least in part on the PDU being part of the set of different PDUs associated with the first PDU set ID.
Aspect 2: The method of aspect 1, further comprising: transmitting, to the network entity, a first subset of the set of different PDUs during a first time duration; identifying that the PDU is part of a second subset of the set of different PDUs that is scheduled to be transmitted after the first time duration; and refraining from transmitting, to the network entity, the second subset of the set of different PDUs based at least in part on the second subset being scheduled to be transmitted after the first time duration, wherein the PDU is not included in the communications with the network entity as a result of the PDU being in the second subset of the set of different PDUs.
Aspect 3: The method of aspect 2, wherein the first time duration is based at least in part on a PDB associated with the first PDU set ID.
Aspect 4: The method of any of aspects 1 through 3, further comprising: transmitting, to the network entity, a first subset of the set of different PDUs; receiving, after transmission of the first subset of the set of different PDUs and before transmission of a second subset of the set of different PDUs, second control information that includes a second PDU set ID that is different from the first PDU set ID; and refraining from transmitting, to the network entity, the second subset of the set of different PDUs based at least in part on the second control information being received before transmission of the second subset of the set of different PDUs, wherein the PDU is not included in the communications with the network entity as a result of the PDU being in the second subset of the set of different PDUs.
Aspect 5: The method of any of aspects 1 through 4, further comprising: transmitting, to the network entity, a first subset of the set of different PDUs; receiving, after transmission of the first subset of the set of different PDUs and before transmission of a second subset of the set of different PDUs, a cancelation signal that indicates that transmission of one or more PDUs of the set of different PDUs is canceled; and refraining from transmitting, to the network entity, the second subset of the set of different PDUs based at least in part on the cancelation signal being received before transmission of the second subset of the set of different PDUs, wherein the PDU is not included in the communications with the network entity as a result of the PDU being in the second subset of the set of different PDUs.
Aspect 6: The method of any of aspect 1 through 5, further comprising: receiving, from the network entity, a first subset of the set of different PDUs during a first time duration; identifying that the PDU is part of a second subset of the set of different PDUs that is scheduled to be received after the first time duration; and refraining from monitoring for the second subset of the set of different PDUs based at least in part on the second subset being scheduled to be received after the first time duration, wherein the PDU is not included in the communications with the network entity as a result of the PDU being in the second subset of the set of different PDUs.
Aspect 7: The method of aspect 6, wherein the first time duration is based at least in part on a PDB associated with the first PDU set ID.
Aspect 8: The method of any of aspects 1 through 7, further comprising: receiving, from the network entity, a first subset of the set of different PDUs; receiving, after receipt of the first subset of the set of different PDUs and before receipt of a second subset of the set of different PDUs, second control information that includes a second PDU set ID that is different from the first PDU set ID; and refraining from monitoring for the second subset of the set of different PDUs based at least in part on the second control information being received before receipt of the second subset of the set of different PDUs, wherein the PDU is not included in the communications with the network entity as a result of the PDU being in the second subset of the set of different PDUs.
Aspect 9: The method of any of aspects 1 through 8, further comprising: receiving, from the network entity, a first subset of the set of different PDUs; receiving, after receipt of the first subset of the set of different PDUs and before receipt of a second subset of the set of different PDUs, a cancelation signal that indicates that transmission by the network entity of one or more PDUs of the set of different PDUs is canceled; and refraining from monitoring for the second subset of the set of different PDUs based at least in part on the cancelation signal being received before receipt of the second subset of the set of different PDUs, wherein the PDU is not included in the communications with the network entity as a result of the PDU being in the second subset of the set of different PDUs.
Aspect 10: The method of any of aspects 1 through 9, wherein receiving the first control information that includes the first PDU set ID further comprises: receiving the first control information in association with a SPS configuration or a CG configuration, wherein reception or transmission opportunities associated with the SPS configuration or the CG configuration, respectively, are scheduled in accordance with a minimum size of a PDU set, a first subset of the set of different PDUs being received or transmitted during the reception or transmission opportunities.
Aspect 11: The method of aspect 10, further comprising: receiving, via a DG, second control information that includes the first PDU set ID, the second control information scheduling a second subset of the set of different PDUs for receipt or transmission, the second subset including one or more PDUs that were not included in the first subset.
Aspect 12: The method of any of aspects 1 through 9, wherein receiving the first control information that includes the first PDU set ID further comprises: receiving the first control information via a DG.
Aspect 13: The method of any of aspects 1 through 9, wherein receiving the first control information that includes the first PDU set ID further comprises: receiving the first control information via activation DCI that activates a SPS configuration or a CG configuration.
Aspect 14: The method of aspect 13, wherein the first PDU set ID in the first control information pertains to a first activated resource instance of the SPS configuration or of the CG configuration.
Aspect 15: The method of aspect 14, wherein subsequent activated resource instances of the SPS configuration or of the CG configuration that are subsequent to the first activated resource instance are associated with different PDU set IDs that have an incremented value with respect to previous activated resource instances.
Aspect 16: The method of any of aspects 1 through 15, further comprising: encoding the set of different PDUs based on the first PDU set ID, wherein an encoding scheme used for encoding the set of different PDUs comprises joint encoding over multiple slots associated with the first PDU set ID, over resources scheduled via SPS and via DG associated with the first PDU set ID, over resources scheduled via CG and via DG associated with the first PDU set ID, or combinations thereof.
Aspect 17: The method of any of aspects 1 through 16, further comprising: decoding the set of different PDUs based on the first PDU set ID, wherein a decoding scheme used for decoding the set of different PDUs comprises joint decoding over multiple slots associated with the first PDU set ID, over resources scheduled via SPS and via DG associated with the first PDU set ID, over resources scheduled via CG and via DG associated with the first PDU set ID, or combinations thereof.
Aspect 18: The method of any of aspects 1 through 17, wherein a coding scheme used to decode or encode the set of different PDUs comprises a rateless code.
Aspect 19: The method of any of aspects 1 through 18, wherein the first PDU set ID comprises one bit with a logic value of one or zero.
Aspect 20: The method of any of aspects 1 through 19, wherein the first PDU set ID comprises more than one bit.
Aspect 21: The method of any of aspects 1 through 20, wherein PDU set-based transmission is enabled via a SPS configuration or a CG configuration, via a non-fallback DCI message, via a dedicated control resource set or search space designated for enabling PDU set-based transmission, or via a DCI message designated for enabling PDU set-based transmission.
Aspect 22: A method for wireless communication at a network entity, comprising: transmitting first control information that includes a first PDU set ID associated with a set of different PDUs that collectively represent a data unit for decoding; and determining whether to include a PDU in communications with a UE, wherein the determining is based at least in part on the PDU being part of the set of different PDUs associated with the first PDU set ID.
Aspect 23: The method of aspect 22, further comprising: receiving, from the UE, a first subset of the set of different PDUs during a first time duration; identifying that the PDU is part of a second subset of the set of different PDUs that is scheduled to be received after the first time duration; and refraining from monitoring for the second subset of the set of different PDUs based at least in part on the second subset being scheduled to be received after the first time duration, wherein the PDU is not included in the communications with the network entity as a result of the PDU being in the second subset of the set of different PDUs.
Aspect 24: The method of any of aspects 22 through 23, further comprising: receiving, from the UE, a first subset of the set of different PDUs; transmitting, after receipt of the first subset of the set of different PDUs and before receipt of a second subset of the set of different PDUs, second control information that includes a second PDU set ID that is different from the first PDU set ID; and refraining from monitoring for the second subset of the set of different PDUs based at least in part on the second control information being transmitted before receipt of the second subset of the set of different PDUs, wherein the PDU is not included in the communications with the network entity as a result of the PDU being in the second subset of the set of different PDUs.
Aspect 25: The method of any of aspects 22 through 24, further comprising: transmitting, to the UE, a first subset of the set of different PDUs during a first time duration; identifying that the PDU is part of a second subset of the set of different PDUs that is scheduled to be transmitted after the first time duration; and refraining from transmitting, to the UE, the second subset of the set of different PDUs based at least in part on the second subset being scheduled to be transmitted after the first time duration, wherein the PDU is not included in the communications with the network entity as a result of the PDU being in the second subset of the set of different PDUs.
Aspect 26: The method of any of aspects 22 through 25, further comprising: transmitting, to the UE, a first subset of the set of different PDUs; transmitting, after transmission of the first subset of the set of different PDUs and before transmission of a second subset of the set of different PDUs, second control information that includes a second PDU set ID that is different from the first PDU set ID; and refraining from transmitting, to the UE, the second subset of the set of different PDUs based at least in part on the second control information being transmitted before transmission of the second subset of the set of different PDUs, wherein the PDU is not included in the communications with the network entity as a result of the PDU being in the second subset of the set of different PDUs.
Aspect 27: An apparatus for wireless communication at a UE, comprising a processor; memory coupled with the processor; and instructions stored in the memory and executable by the processor to cause the apparatus to perform a method of any of aspects 1 through 21.
Aspect 28: An apparatus for wireless communication at a UE, comprising at least one means for performing a method of any of aspects 1 through 21.
Aspect 29: A non-transitory computer-readable medium storing code for wireless communication at a UE, the code comprising instructions executable by a processor to perform a method of any of aspects 1 through 21.
Aspect 30: An apparatus for wireless communication at a network entity, comprising a processor; memory coupled with the processor; and instructions stored in the memory and executable by the processor to cause the apparatus to perform a method of any of aspects 22 through 26.
Aspect 31: An apparatus for wireless communication at a network entity, comprising at least one means for performing a method of any of aspects 22 through 26.
Aspect 32: A non-transitory computer-readable medium storing code for wireless communication at a network entity, the code comprising instructions executable by a processor to perform a method of any of aspects 22 through 26.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a user equipment (UE), comprising:
receiving first control information that includes a first packet data unit set identifier associated with a set of different packet data units that collectively represent a data unit for decoding;
identifying a packet data unit is a part of the set of different packet data units that corresponds to the first packet data unit set identifier based at least in part on the first control information; and
determining whether to include the packet data unit in communications with a network entity, wherein the determining is based at least in part on the packet data unit being part of the set of different packet data units associated with the first packet data unit set identifier.

2. The method of claim 1, further comprising:
transmitting, to the network entity, a first subset of the set of different packet data units during a first time duration;
identifying that the packet data unit is part of a second subset of the set of different packet data units that is scheduled to be transmitted after the first time duration; and
refraining from transmitting, to the network entity, the second subset of the set of different packet data units based at least in part on the second subset being scheduled to be transmitted after the first time duration, wherein the packet data unit is not included in the communications with the network entity as a result of the packet data unit being in the second subset of the set of different packet data units.

3. The method of claim 2, wherein the first time duration is based at least in part on a packet delay budget associated with the first packet data unit set identifier.

4. The method of claim 1, further comprising:
transmitting, to the network entity, a first subset of the set of different packet data units;
receiving, after transmission of the first subset of the set of different packet data units and before transmission of a second subset of the set of different packet data units, second control information that includes a second packet data unit set identifier that is different from the first packet data unit set identifier; and
refraining from transmitting, to the network entity, the second subset of the set of different packet data units based at least in part on the second control information being received before transmission of the second subset of the set of different packet data units, wherein the packet data unit is not included in the communications with the network entity as a result of the packet data unit being in the second subset of the set of different packet data units.

5. The method of claim 1, further comprising:
transmitting, to the network entity, a first subset of the set of different packet data units;
receiving, after transmission of the first subset of the set of different packet data units and before transmission of a second subset of the set of different packet data units, a cancelation signal that indicates that transmission of one or more packet data units of the set of different packet data units is canceled; and
refraining from transmitting, to the network entity, the second subset of the set of different packet data units based at least in part on the cancelation signal being received before transmission of the second subset of the set of different packet data units, wherein the packet data unit is not included in the communications with the network entity as a result of the packet data unit being in the second subset of the set of different packet data units.

6. The method of claim 1, further comprising:
receiving, from the network entity, a first subset of the set of different packet data units during a first time duration;
identifying that the packet data unit is part of a second subset of the set of different packet data units that is scheduled to be received after the first time duration; and
refraining from monitoring for the second subset of the set of different packet data units based at least in part on the second subset being scheduled to be received after the first time duration, wherein the packet data unit is not included in the communications with the network entity as a result of the packet data unit being in the second subset of the set of different packet data units.

7. The method of claim 6, wherein the first time duration is based at least in part on a packet delay budget associated with the first packet data unit set identifier.

8. The method of claim 1, further comprising:
receiving, from the network entity, a first subset of the set of different packet data units;
receiving, after receipt of the first subset of the set of different packet data units and before receipt of a second subset of the set of different packet data units, second control information that includes a second packet data unit set identifier that is different from the first packet data unit set identifier; and
refraining from monitoring for the second subset of the set of different packet data units based at least in part on the second control information being received before receipt of the second subset of the set of different packet data units, wherein the packet data unit is not included in the communications with the network entity as a result of the packet data unit being in the second subset of the set of different packet data units.

9. The method of claim 1, further comprising:
receiving, from the network entity, a first subset of the set of different packet data units;
receiving, after receipt of the first subset of the set of different packet data units and before receipt of a second subset of the set of different packet data units, a cancelation signal that indicates that transmission by the network entity of one or more packet data units of the set of different packet data units is canceled; and
refraining from monitoring for the second subset of the set of different packet data units based at least in part on the cancelation signal being received before receipt of the second subset of the set of different packet data units, wherein the packet data unit is not included in the communications with the network entity as a result of the packet data unit being in the second subset of the set of different packet data units.

10. The method of claim 1, wherein receiving the first control information that includes the first packet data unit set identifier further comprises:
receiving the first control information in association with a semi-persistent scheduling configuration or a configured grant configuration, wherein reception or transmission opportunities associated with the semi-persistent scheduling configuration or the configured grant configuration, respectively, are scheduled in accordance with a minimum size of a packet data unit set, a first subset of the set of different packet data units being received or transmitted during the reception or transmission opportunities.

11. The method of claim 10, further comprising:
receiving, via a dynamic grant, second control information that includes the first packet data unit set identifier, the second control information scheduling a second subset of the set of different packet data units for receipt or transmission, the second subset including one or more packet data units that were not included in the first subset.

12. The method of claim 1, wherein receiving the first control information that includes the first packet data unit set identifier further comprises:
receiving the first control information via a dynamic grant.

13. The method of claim 1, wherein receiving the first control information that includes the first packet data unit set identifier further comprises:
receiving the first control information via activation downlink control information that activates a semi-persistent scheduling configuration or a configured grant configuration.

14. The method of claim 13, wherein the first packet data unit set identifier in the first control information pertains to a first activated resource instance of the semi-persistent scheduling configuration or of the configured grant configuration.

15. The method of claim 14, wherein subsequent activated resource instances of the semi-persistent scheduling configuration or of the configured grant configuration that are subsequent to the first activated resource instance are associated with different packet data unit set identifiers that have an incremented value with respect to previous activated resource instances.

16. The method of claim 1, further comprising:
encoding the set of different packet data units based on the first packet data unit set identifier, wherein an encoding scheme used for encoding the set of different packet data units comprises joint encoding over multiple slots associated with the first packet data unit set identifier, over resources scheduled via semi-persistent scheduling and via dynamic grant associated with the first packet data unit set identifier, over resources scheduled via configured grant and via dynamic grant associated with the first packet data unit set identifier, or combinations thereof.

17. The method of claim 1, further comprising:
decoding the set of different packet data units based on the first packet data unit set identifier, wherein a decoding scheme used for decoding the set of different packet data units comprises joint decoding over multiple slots associated with the first packet data unit set identifier, over resources scheduled via semi-persistent scheduling and via dynamic grant associated with the first packet data unit set identifier, over resources scheduled via configured grant and via dynamic grant associated with the first packet data unit set identifier, or combinations thereof.

18. The method of claim 1, wherein a coding scheme used to decode or encode the set of different packet data units comprises a rateless code.

19. The method of claim 1, wherein the first packet data unit set identifier comprises one bit with a logic value of one or zero.

20. The method of claim 1, wherein the first packet data unit set identifier comprises more than one bit.

21. The method of claim 1, wherein packet data unit set-based transmission is enabled via a semi-persistent scheduling configuration or a configured grant configuration, via a non-fallback downlink control information message, via a dedicated control resource set or search space designated for enabling packet data unit set-based transmission, or via a downlink control information message designated for enabling packet data unit set-based transmission.

22. A method for wireless communication at a network entity, comprising:
transmitting first control information that includes a first packet data unit set identifier associated with a set of different packet data units that collectively represent a data unit for decoding; and
determining whether to include a packet data unit in communications with a user equipment (UE), wherein the determining is based at least in part on the packet data unit being part of the set of different packet data units associated with the first packet data unit set identifier.

23. The method of claim 22, further comprising:
receiving, from the UE, a first subset of the set of different packet data units during a first time duration;
identifying that the packet data unit is part of a second subset of the set of different packet data units that is scheduled to be received after the first time duration; and
refraining from monitoring for the second subset of the set of different packet data units based at least in part on the second subset being scheduled to be received after the first time duration, wherein the packet data unit is not included in the communications with the network entity as a result of the packet data unit being in the second subset of the set of different packet data units.

24. The method of claim 22, further comprising:
receiving, from the UE, a first subset of the set of different packet data units;
transmitting, after receipt of the first subset of the set of different packet data units and before receipt of a second subset of the set of different packet data units, second control information that includes a second packet data unit set identifier that is different from the first packet data unit set identifier; and
refraining from monitoring for the second subset of the set of different packet data units based at least in part on the second control information being transmitted before receipt of the second subset of the set of different packet data units, wherein the packet data unit is not included in the communications with the network entity as a result of the packet data unit being in the second subset of the set of different packet data units.

25. The method of claim 22, further comprising:
transmitting, to the UE, a first subset of the set of different packet data units during a first time duration;
identifying that the packet data unit is part of a second subset of the set of different packet data units that is scheduled to be transmitted after the first time duration; and
refraining from transmitting, to the UE, the second subset of the set of different packet data units based at least in part on the second subset being scheduled to be transmitted after the first time duration, wherein the packet data unit is not included in the communications with the network entity as a result of the packet data unit being in the second subset of the set of different packet data units.

26. The method of claim 22, further comprising:
transmitting, to the UE, a first subset of the set of different packet data units;
transmitting, after transmission of the first subset of the set of different packet data units and before transmission of a second subset of the set of different packet data units, second control information that includes a second packet data unit set identifier that is different from the first packet data unit set identifier; and
refraining from transmitting, to the UE, the second subset of the set of different packet data units based at least in part on the second control information being transmitted before transmission of the second subset of the set of different packet data units, wherein the packet data unit is not included in the communications with the network entity as a result of the packet data unit being in the second subset of the set of different packet data units.

27. An apparatus for wireless communication at a user equipment (UE), comprising:
a processor;
memory coupled with the processor; and
instructions stored in the memory and executable by the processor to cause the apparatus to:
receive first control information that includes a first packet data unit set identifier associated with a set of different packet data units that collectively represent a data unit for decoding;
identify a packet data unit is a part of the set of different packet data units that corresponds to the first packet data unit set identifier based at least in part on the first control information; and
determine whether to include the packet data unit in communications with a network entity, wherein the determining is based at least in part on the packet data unit being part of the set of different packet data units associated with the first packet data unit set identifier.

28. The apparatus of claim 27, wherein the instructions are further executable by the processor to cause the apparatus to:
transmit, to the network entity, a first subset of the set of different packet data units during a first time duration;
identify that the packet data unit is part of a second subset of the set of different packet data units that is scheduled to be transmitted after the first time duration; and
refrain from transmitting, to the network entity, the second subset of the set of different packet data units based at least in part on the second subset being scheduled to be transmitted after the first time duration, wherein the packet data unit is not included in the communications with the network entity as a result of the packet data unit being in the second subset of the set of different packet data units.

29. An apparatus for wireless communication at a network entity, comprising:
a processor;
memory coupled with the processor; and
instructions stored in the memory and executable by the processor to cause the apparatus to:
transmit first control information that includes a first packet data unit set identifier associated with a set of different packet data units that collectively represent a data unit for decoding; and
determine whether to include a packet data unit in communications with a user equipment (UE), wherein the determining is based at least in part on the packet data unit being part of the set of different packet data units associated with the first packet data unit set identifier.

30. The apparatus of claim 29, wherein the instructions are further executable by the processor to cause the apparatus to:
receive, from the UE, a first subset of the set of different packet data units during a first time duration;
identify that the packet data unit is part of a second subset of the set of different packet data units that is scheduled to be received after the first time duration; and
refrain from monitoring for the second subset of the set of different packet data units based at least in part on the second subset being scheduled to be received after the first time duration, wherein the packet data unit is not included in the communications with the network entity as a result of the packet data unit being in the second subset of the set of different packet data units.
